(19) United States
(12) Patent Application Publication
(10) Pub. No.: US 2025/0164999 A1
(43) Pub. Date: May 22, 2025

(54) INFORMATION PROCESSING SYSTEM, AUTONOMOUS TRAVELING BODY, INFORMATION PROCESSING APPARATUS, METHOD FOR CONTROLLING AUTONOMOUS TRAVELING BODY AND RECORDING MEDIUM

(71) Applicants: Aiko OHTSUKA, Tokyo (JP); Koichi KUDO, Kanagawa (JP); Masuyoshi YACHIDA, Tokyo (JP); Hanako BANDO, Ibaraki (JP); Mototsugu MUROI, Kanagawa (JP)

(72) Inventors: Aiko OHTSUKA, Tokyo (JP); Koichi KUDO, Kanagawa (JP); Masuyoshi YACHIDA, Tokyo (JP); Hanako BANDO, Ibaraki (JP); Mototsugu MUROI, Kanagawa (JP)

(21) Appl. No.: 18/839,031

(22) PCT Filed: Mar. 17, 2023
(86) PCT No.: PCT/IB2023/052615

§ 371 Date: Aug. 16, 2024

(30) Foreign Application Priority Data
Mar. 23, 2022 (JP) 2022-046373
Mar. 23, 2022 (JP) 2022-046426
Jan. 27, 2023 (JP) 2023-011034
Jan. 27, 2023 (JP) 2023-011214

(51) Int. Cl. G05D 1/227; G05D 1/24; G05D 107/60; G05D 107/70; G05D 109/10; G05D 111/10

(52) U.S. Cl. CPC G05D 1/2278; G05D 1/24; G05D 2107/65; G05D 2107/70; G05D 2109/10; G05D 2111/10

(57) ABSTRACT

An information processing system controls an autonomous traveling body capable of autonomously traveling on a learned route. The information processing system includes a route information storage unit to store suspension point information indicating a suspension point at which the autonomous traveling body has suspended autonomous traveling on a particular learned route, and an acquisition unit to acquire current position information indicating a current position of the autonomous traveling body according to an instruction to resume the autonomous traveling, and controls the autonomous traveling body to return to the particular route, based on at least the current position information and the suspension point information.

### TECHNICAL FIELD

The present disclosure relates to an information processing system, an autonomous traveling body, an information processing apparatus, a method for controlling an autonomous traveling body, and a recording medium.

### BACKGROUND ART

In work such as inspection and security work, a traveling body to travel under remote control is used in some cases.

From the viewpoint of reducing a burden on an operator, traveling bodies capable of autonomous traveling have been developed. In autonomous traveling, the traveling body automatically travels on a route learned in advance (hereinafter, also referred to as an “autonomous traveling device”).

There is a technique for switching between a remote control mode and an autonomous traveling mode. For example, when an autonomous traveling device has suspended autonomous traveling due to the detection of an obstacle on the route while autonomously traveling, the mode is switched to the remote control mode and again switched to the autonomous traveling mode.

There is an autonomous traveling device that sequentially executes a plurality of tasks in the work such as inspection work.

For example, Patent Literature (PTL) 1 discloses a configuration for resetting an execution plan of registered tasks in accordance with a remaining battery level and controlling the autonomous traveling device to execute the tasks according to a re-created execution plan. According to PTL 1, the autonomous traveling device (traveling robot) can efficiently execute a plurality of tasks even under a condition where there is an unexpected factor.

### CITATION LIST

### Patent Literature

[PTL 1]
Japanese Unexamined Patent Application Publication No. 2006-106919

### SUMMARY OF INVENTION

### Technical Problem

However, when the autonomous traveling suspended due to various causes is resumed, it is possible that the autonomous traveling device has moved from the point where the autonomous traveling was suspended.

In such a case, the autonomous traveling device may be located at a position deviated from the route on which the autonomous traveling device has traveled until the suspension. Then, autonomous traveling devices according to the related arts including PTL 1 may fail to resume the interrupted autonomous traveling and fail to complete the task which is being executed.

There is a demand for a technique for returning the autonomous traveling device to autonomous traveling. In view of the foregoing, an object of the present disclosure is to provide an information processing system, an information processing apparatus, and an autonomous traveling body capable of resuming suspended autonomous traveling.

### Solution to Problem

In one aspect, an information processing system controls an autonomous traveling body capable of autonomously traveling on a learned route. The information processing system includes a route information storage unit to store suspension point information indicating a suspension point at which the autonomous traveling body has suspended autonomous traveling on a particular learned route, and an acquisition unit to acquire current position information indicating a current position of the autonomous traveling body according to an instruction to resume the autonomous traveling, and controls the autonomous traveling body to return to the particular route, based on at least the current position information and the suspension point information.

Another aspect concerns an autonomous traveling body capable of autonomously traveling on a learned route. The autonomous traveling body includes a route information storage unit configured to store suspension point information indicating a suspension point at which the autonomous traveling body has suspended autonomous traveling on a particular route that is a learned route; an acquisition unit configured to acquire current position information indicating a current position of the autonomous traveling body according to an instruction to resume the autonomous traveling; and a control unit configured to control the autonomous traveling body to return to the particular route, based on the current position information and the suspension point information.

Another aspect concerns an information processing system for controlling an autonomous traveling body that performs switching between an autonomous traveling mode in which the autonomous traveling body autonomously travels on a predetermined route and a remote control mode in which the autonomous traveling body is controlled to travel by a remote operation. The information processing system includes a notification unit configured to provide information on the switching in accordance with whether the autonomous traveling body is located on the predetermined route.

Another aspect concerns an autonomous traveling body that communicates with a control terminal that receives an operation by a user. The autonomous traveling body performs switching between an autonomous traveling mode in which the autonomous traveling body autonomously travels on a predetermined route and a remote control mode in which the autonomous traveling body operates according to an operation received on the control terminal.

Another aspect concerns an autonomous traveling body that performs switching between an autonomous traveling mode in which the autonomous traveling body autonomously travels on a predetermined route and a remote control mode in which the autonomous traveling body is controlled to travel by a remote operation. The autonomous traveling body rejects an operation of switching to the autonomous traveling mode, based on a determination that the autonomous traveling body is not located on the predetermined route.

Another aspect concerns an information processing apparatus for controlling an autonomous traveling body that performs switching between an autonomous traveling mode in which the autonomous traveling body autonomously travels on a predetermined route and a remote control mode in which the autonomous traveling body is controlled to travel by a remote operation. The information processing apparatus includes a notification unit to provide information on the switching in accordance with whether the autonomous traveling body is located on the predetermined route.

Another aspect concerns a method performed by an information processing system for controlling an autonomous traveling body that performs switching between an autonomous traveling mode in which the autonomous traveling body autonomously travels on a predetermined route and a remote control mode in which the autonomous traveling body is controlled to travel by a remote operation. The method includes providing information on the switching in accordance with whether the autonomous traveling body is located on the predetermined route.

Another aspect concerns a recording medium storing a plurality of program codes which, when executed by one or more processors, causes the processors to perform the method described above.

### Advantageous Effects of Invention

According to embodiments of the present disclosure, the information processing system, an information processing apparatus, and the autonomous traveling body capable of resuming the suspended autonomous traveling can be provided.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a schematic diagram illustrating a hardware configuration of a system according to a first embodiment.

FIG. 2A is a block diagram of a hardware configuration of an autonomous traveling device according to embodiments.

FIG. 2B is a block diagram of a hardware configuration of a control terminal according to embodiments.

FIG. 2C is a block diagram of a hardware configuration of a server according to embodiments.

FIG. 3 is a schematic block diagram illustrating a software configuration of the system according to the first embodiment.

FIG. 4 is a flowchart illustrating a process of switching a control mode of the autonomous traveling device in the system according to the first embodiment.

FIG. 5 is a diagram illustrating mode transition of the autonomous traveling device according to the first embodiment.

FIG. 6 is a diagram illustrating a display screen according to the first embodiment.

FIG. 7A is a diagram illustrating another display screen in the first embodiment.

FIG. 7B is a diagram illustrating another display screen in the first embodiment.

FIG. 8A is a diagram illustrating another display screen according to the first embodiment.

FIG. 8B is a diagram illustrating another display screen according to the first embodiment.

FIG. 9 is a diagram illustrating a route learned according to the first embodiment.

FIG. 10A illustrates an example of a table of route information stored in a route information storage unit according to the first embodiment.

FIG. 10B illustrates an example of a table of waypoints and checkpoints stored in a route information storage unit according to the first embodiment.

FIG. 10C illustrates an example of a table of inspection points.

FIG. 10D illustrates another example of the table of inspection points.

FIG. 11 is a flowchart illustrating a process performed when autonomous traveling is suspended, according to the first embodiment.

FIG. 12 is a diagram illustrating an example of suspended autonomous traveling of the autonomous traveling device in the first embodiment.

FIG. 13 is a flowchart illustrating a process of resuming the suspended autonomous traveling, according to the first embodiment.

FIG. 14 is a diagram illustrating a first example of traveling of the autonomous traveling device to a recovery point.

FIG. 15 is a diagram illustrating a second example of traveling of the autonomous traveling device to the recovery point.

FIG. 16 is a diagram illustrating a third example of traveling of the autonomous traveling device to the recovery point.

FIG. 17 is a diagram illustrating a fourth example of traveling of the autonomous traveling device to the recovery point.

FIG. 18 is a flowchart illustrating a process for the autonomous traveling device having suspended autonomous traveling to store a route, according to the first embodiment.

FIG. 19 is a diagram illustrating an example in which the autonomous traveling device is not able to autonomously travel to a recovery point, according to the present embodiment.

FIG. 20 is a schematic diagram illustrating a hardware configuration of a system according to a second embodiment.

FIG. 21 is a block diagram illustrating a software configuration of the system according to the second embodiment.

FIG. 22 is a schematic diagram illustrating a hardware configuration of a system according to a third embodiment.

FIG. 23 is a block diagram illustrating a software configuration of the system according to the third embodiment.

FIG. 24 illustrates an example of a table stored in a stop-situation storage unit according to the third embodiment.

FIG. 25 is a flowchart illustrating a process for notification of a probability of stop in the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. Although example embodiments of the present invention are described below, embodiments of the present invention are not limited thereto.

In the drawings referred below, the same or similar reference codes are used for the common or corresponding elements, and redundant descriptions are omitted as appropriate.

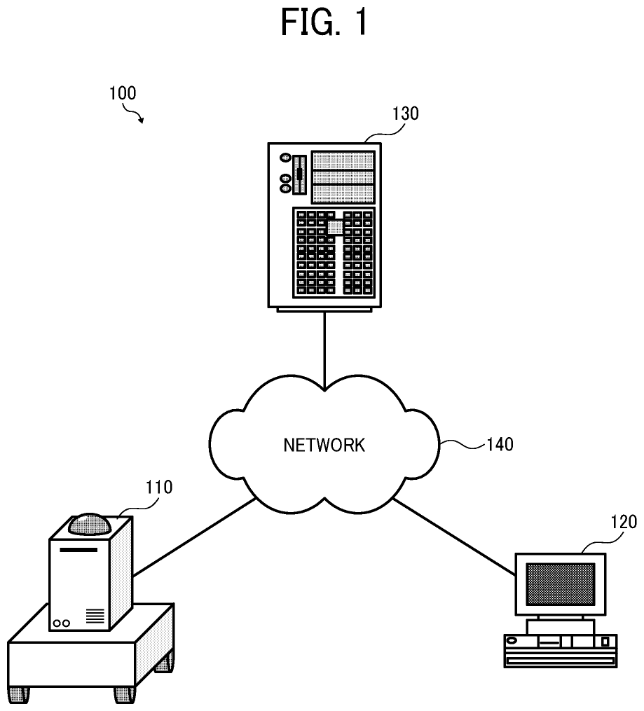

FIG. 1 is a schematic diagram illustrating a hardware configuration of a system 100 according to a first embodiment.

FIG. 1 illustrates, as an example, an environment in which an autonomous traveling device 110, a control terminal 120, and a server 130 are connected via a network 140 such as the Internet or a local area network (LAN).

The number of each of the autonomous traveling device 110, the control terminal 120, and the server 130 included in the system 100 is not limited to that illustrated in FIG. 1.

the autonomous traveling device 110, the control terminal 120, and the server 130 may be connected to the network 140 by any means, such as wired or wireless.

The system 100 is an example of an information processing system according to the present disclosure, which controls an autonomous traveling body.

In the present embodiment, the system 100 that controls the autonomous traveling device 110 includes the control terminal 120 and the server 130.

The autonomous traveling device 110 (autonomous traveling body) is a robot installed at an operation site and autonomously moves from one location to another location in the operation site.

For example, the autonomous travel is operation of autonomously traveling the operation site, using a result of machine learning of the past traveling routes.

The autonomous travel may be operation of autonomously traveling the operation site along a traveling route preliminarily set, or operation of autonomously traveling the operation site using a technique such as line tracing. Hereinafter, an “autonomous travel mode” (first mode) refers to a mode in which the autonomous traveling device 110 travels by autonomous travel.

Further, the autonomous traveling device 110 can be controlled to travel according to a manual operation (remote control) by a user at a remote place. Such a mode is referred to as a “remote control mode” (second mode).

In other words, the autonomous traveling device 110 can travel the operation site while switching between the autonomous travel mode and the remote control mode.

The autonomous traveling device 110 according to the present embodiment executes a preset task such as an inspection, maintenance, transportation, guarding, or light work, while traveling the operation site.

In the present embodiment, the traveling body is the autonomous traveling device 110 that travels with wheels but is not limited thereto. Aspects of the present disclosure may be embodied is a flying object such as a drone, a multicopter, or an unattended flying object.

Further, the autonomous traveling device 110 can function as a general-purpose computer.

The control terminal 120 is, for example, an information processing apparatus such as a personal computer, and can control the operation of the autonomous traveling device 110, receiving input of operation by a user.

The control terminal 120 according to the present embodiment can switch the control mode (traveling mode) of the autonomous traveling device 110 between the autonomous traveling mode and the remote control mode.

When the autonomous traveling device 110 is in the remote control mode, the control terminal 120 can display an image from the autonomous traveling device 110 and control a traveling direction, a traveling speed, and the like of the autonomous traveling device 110.

Furthermore, in an inspection work or the like performed by the autonomous traveling device 110, the control terminal 120 can check an object to be inspected.

The server 130 is an information processing apparatus that provides services related to the control of the autonomous traveling device 110 according to the present embodiment.

For example, the server 130 manages the autonomous traveling device 110 and the control terminal 120 and, in particular, manages the devices and the operation site in association with each other.

The server 130 can function as a general-purpose computer.

In the present embodiment, for example, the server 130 may use an authentication process provided by a cloud computing service during communication.

Such authentication process secures safety in communication such as transmission of an operation command by the control terminal 120 and transmission of image data from the autonomous traveling device 110.

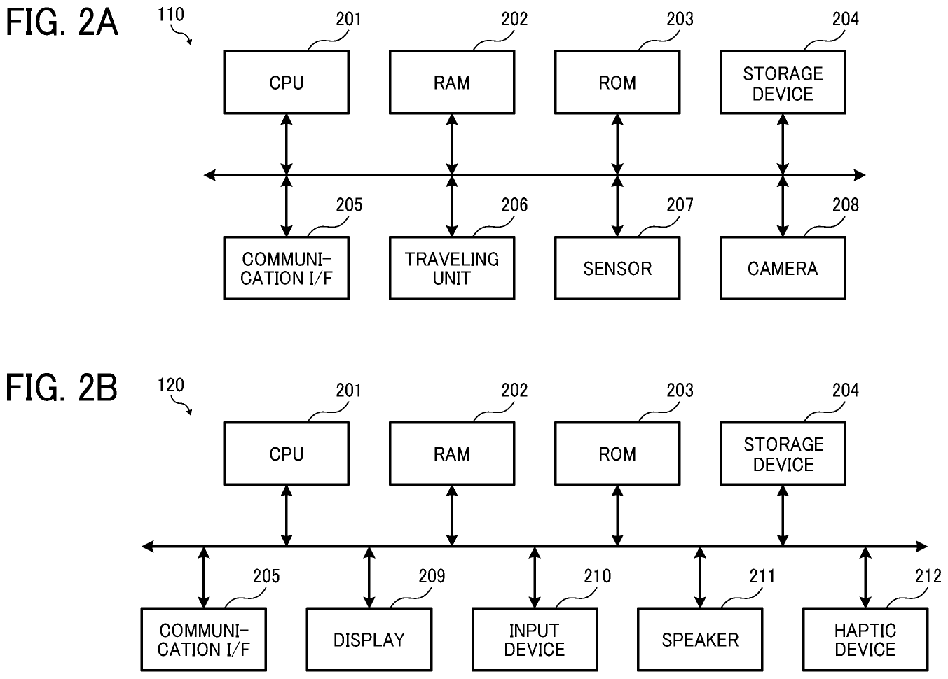

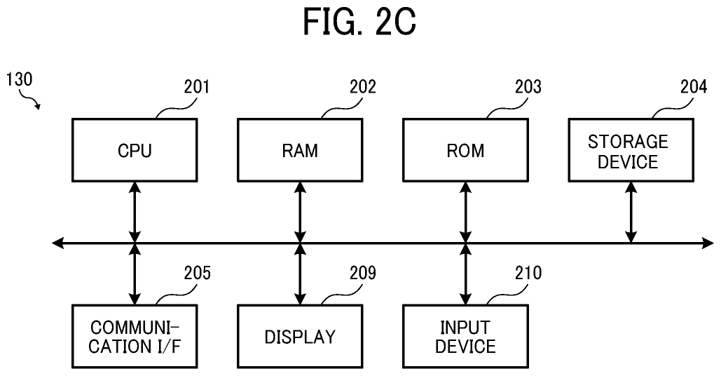

Next, descriptions are given of hardware configurations of the devices included in the system 100 according to the present embodiment, with reference to FIGS. 2A to 2C.

FIG. 2A illustrates the hardware configuration of the autonomous traveling device 110. FIG. 2B illustrates the hardware configuration of the control terminal 120. FIG. 2C illustrates the hardware configuration of the server 130.

First, as illustrated in FIG. 2A, the autonomous traveling device 110 includes a central processing unit (CPU) 201, a random access memory (RAM) 202, a read only memory (ROM) 203, a storage device 204 (a storage device), a communication interface (I/F) 205, a traveling unit 206, a sensor 207, and a camera 208. Each hardware component is connected with each other via a bus.

The CPU 201 executes a program for controlling the operation of the autonomous traveling device 110 to perform predetermined processing.

The RAM 202 is a volatile storage device to provide a work area for the CPU 201 executing programs. The RAM 202 is used to store and load programs and data.

The ROM 203 is a nonvolatile storage device to store programs and firmware, etc., executed by the CPU 201.

The storage device 204 is a readable and writable non-volatile storage device having a memory that stores an operating system (OS) for operating the autonomous traveling device 110, various software, setting information, and various data including leaned route data relating to the autonomous traveling.

Examples of the storage device 204 include a hard disk drive (HDD) and a solid state drive (SSD).

The communication I/F 205 (a communication unit) connects the autonomous traveling device 110 to the network 140 to enable the autonomous traveling device 110 to communicate with other devices via the network 140.

The communication via the network 140 may be performed in compliant with a predetermined communication protocol such as Transmission Control Protocol (TCP)/Internet Protocol (IP), to transmit and receive various data.

The traveling unit 206 is a moving mechanism related to the traveling of the autonomous traveling device 110 and includes a battery and a motor for example.

The sensor 207 detects, for example, a traveling state of the autonomous traveling device 110 and a surrounding situation, and examples thereof include a position confirmation sensor such as a global positioning system (GPS), and an obstacle sensor.

The autonomous traveling device 110 can check a deviation from a predetermined route, for example, by acquiring the current position of the autonomous traveling device 110 itself using a position confirmation sensor.

In addition, the autonomous traveling device 110 determines the presence or absence of an obstacle, a step, or the like on a traveling road with the obstacle sensor and takes an avoidance action.

The sensor 207 according to the present embodiment can also be used in an inspection work.

For example, when a temperature sensor, a sound sensor, a gas detection sensor, or the like is employed as the sensor 207, various kinds of data related to the object to be inspected can be acquired and used in the inspection.

The camera 208 is a device that captures an image of the surroundings of the autonomous traveling device 110.

The image captured by the camera 208 is transmitted to the control terminal 120 via the network 140, and is used to grasp the situation surrounding the autonomous traveling device 110 at the time of remote control by the user.

When the autonomous traveling device 110 performs an inspection work, an object to be inspected may be confirmed by an image captured by the camera 208.

Similar to the data acquired by the sensor 207, the image may be used to determine the presence or absence of an obstacle, a step, or the like on the traveling road during autonomous traveling.

Next, referring to FIG. 2B, the control terminal 120 includes the CPU 201, the RAM 202, the ROM 203, the storage device 204, the communication I/F 205, a display 209, an input device 210, a speaker 211, and a haptic device 212. Each hardware component is connected with each other via a bus.

The CPU 201, the RAM 202, the ROM 203, the storage device 204, and the communication I/F 205 are similar to those of the autonomous traveling device 110 described with reference to FIG. 2A, and thus a detailed description thereof will be omitted.

The display 209, which may be a liquid crystal display (LCD), displays various data, an operating state of the devices to the user.

The input device 210, which may be implemented by a keyboard or a mouse, allows the user to operate the devices.

The input device 210 included in the control terminal 120 may be a device, such as a joystick, dedicated to the control of a mobile device.

The display 209 and the input device 210 may be separate devices, or may be combined into one device such as a touch panel display.

The speaker 211 is a device that emits sound converted from an electric signal.

The speaker 211 according to the present embodiment can emit alarm sound, a voice, or the like, and can notify the user of, for example, a state of the autonomous traveling device 110 by sound.

The haptic device 212 is a device that converts an electric signal into, for example, force, vibration, or motion so that the user feels a tactile sense.

The haptic device 212 according to the present embodiment can notify the user of, for example, the state of the autonomous traveling device 110 by applying a predetermined vibration to the user.

In the following description of the embodiment, the display 209, the speaker 211, and the haptic device 212 may be collectively referred to as a notification device.

In addition, the notification device serves as a notification unit of the present embodiment.

Next, with reference to FIG. 2C, the server 130 includes the CPU 201, the RAM 202, the ROM 203, the storage device 204, the communication I/F 205, the display 209, and the input device 210. Each hardware component is connected with each other via a bus.

Each hardware component included in the server 130 is similar to that of the autonomous traveling device 110 and the control terminal 120 described with reference to FIGS. 2A and 2B, and thus a detailed description thereof will be omitted.

The hardware configurations of the devices according to the present embodiment have been described above.

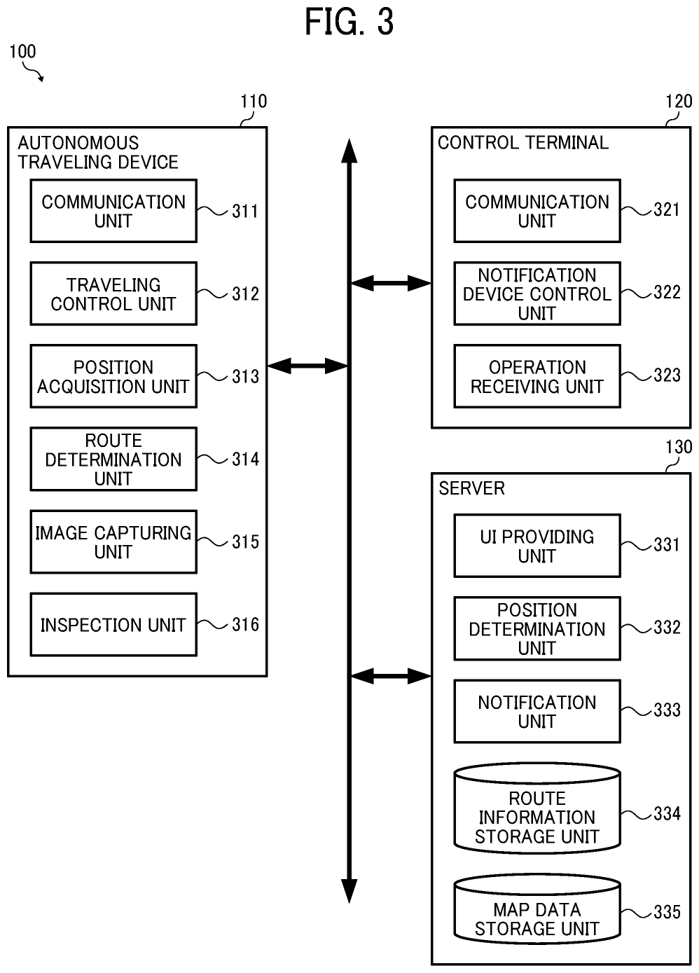

Next, with reference to FIG. 3, descriptions are given below of functional units executed by one or more above-described hardware components, according to the present embodiment.

FIG. 3 is a schematic block diagram illustrating a software configuration of the system 100 according to the present embodiment.

As illustrated in FIG. 3, the autonomous traveling device 110 according to the present embodiment includes, as functional units, a communication unit 311, a traveling control unit 312, a position acquisition unit 313, a route determination unit 314, an image capturing unit 315, and an inspection unit 316.

The control terminal 120 according to the present embodiment includes, as functional units, a communication unit 321, a notification device control unit 322, and an operation receiving unit 323.

The server 130 according to the present embodiment includes, as functional units, a user interface (UI) providing unit 331, a position determination unit 332, a notification unit 333, a route information storage unit 334, and a map data storage unit 335.

The functional units will be described in detail below.

First, the autonomous traveling device 110 will be described.

The communication unit 311 controls the communication I/F 205 and performs communication with other devices.

The communication unit 311 according to the present embodiment receives data related to operating the autonomous traveling device 110 from the control terminal 120 and transmits captured images, data collected for an inspection, and the like.

The traveling control unit 312 is a control unit for controlling the operation of the traveling unit 206.

The traveling control unit 312 of the present embodiment can switch the control mode between the autonomous traveling mode and the remote control mode.

The traveling control unit 312 controls the traveling unit 206 so as to travel a predetermined route in the autonomous traveling mode, and controls the traveling unit 206 based on the data related to operating the autonomous traveling device 110, received from the control terminal 120 in the remote control mode.

The position acquisition unit 313 calculates a current position of the autonomous traveling device 110 based on data acquired by the sensor 207 such as a GPS.

The route determination unit 314 determines whether or not there is a route for the autonomous traveling device 110 to travel to resume the autonomous traveling that has been suspended.

The route determination unit 314 of the present embodiment can determine an appropriate route based on, for example, the determination result by the position determination unit 332 and the route stored in the route information storage unit 334.

The image capturing unit 315 controls the camera 208 to capture an image of the surroundings of the autonomous traveling device 110.

The inspection unit 316 measures various data by various sensors (the sensor 207) included in the autonomous traveling device 110 and performs an inspection.

The inspection unit 316 can perform, for example, gas detection, noise measurement, or temperature measurement.

Next, the control terminal 120 will be described.

The communication unit 321 controls the communication I/F 205 and performs communication with other devices. For example, the communication unit 321 according to the present embodiment can receive position information of the autonomous traveling device 110, captured images, and map data from the server 130 and transmit the data related to operating the autonomous traveling device 110.

The notification device control unit 322 controls operations of various notification devices such as the display 209, the speaker 211, and the haptic device 212.

The notification device control unit 322 according to the present embodiment controls the notification devices so that the user recognizes the notification through visual sense, auditory sense, or tactile sense. Through such a method, the user is notified of, for example, a state of the autonomous traveling device 110.

For example, the notification device control unit 322 of the present embodiment displays an image captured by the autonomous traveling device 110 or an operation screen on the display 209, so as to indicate the state of the autonomous traveling device 110. Alternatively, the notification device control unit 322 controls the speaker 211 to emit sound or the haptic device 212 to output, for example, vibration, to indicate the state of the autonomous traveling device 110.

The operation receiving unit 323 receives an operation input by a user via the input device 210.

The operation receiving unit 323 can receive a command related to operating the autonomous traveling device 110 and transmit the command to the autonomous traveling device 110 via the communication unit 321.

Next, the server 130 will be described.

The UI providing unit 331 provides the UI of the service according to the present embodiment to the control terminal 120.

The position determination unit 332 determines whether or not the current position of the autonomous traveling device 110 acquired by the position acquisition unit 313 of the autonomous traveling device 110 is on the learned route.

The notification unit 333 notifies the control terminal 120 of the state of the autonomous traveling device 110.

The route information storage unit 334 is a storage unit that controls the storage device 204 and stores route information on which the autonomous traveling device 110 travels.

The route information storage unit 334 according to the present embodiment can store, for example, route information learned in advance for autonomous traveling and route information on which the autonomous traveling device 110 has traveled at the time of remote control.

In addition, the route information storage unit 334 can store a suspension point at which autonomous traveling is suspended in association with a route related to the autonomous traveling.

The map data storage unit 335 controls the storage device 204 to store the map data of the operation site.

The software blocks described above correspond to functional units implemented by the CPU 201 executing a program of the present embodiment, to operate the hardware components.

Each of the above-described functional units may be implemented by software, hardware, or a combination of software and hardware.

Further, all of the above-described functional units do not necessarily have to be in the blocks as illustrated in FIG. 3.

For example, the control terminal 120 may include the UI providing unit 331, the map data storage unit 335, and the route determination unit 314. Alternatively, the autonomous traveling device 110 or the control terminal 120 may include the route information storage unit 334.

For example, in another embodiment, any one of the above-described functional units may be implemented by cooperation among the autonomous traveling device 110, the control terminal 120, and the server 130.

In another embodiment, the autonomous traveling device 110 may include only functional units related to autonomous traveling and inspection, and other functional units may be included in other apparatuses (devices) of the system 100.

In such a case, the autonomous traveling device 110 may collect various types of information and transmit the information to the control terminal 120 or the server 130, and the control terminal 120 or the server 130 may perform various types of control.

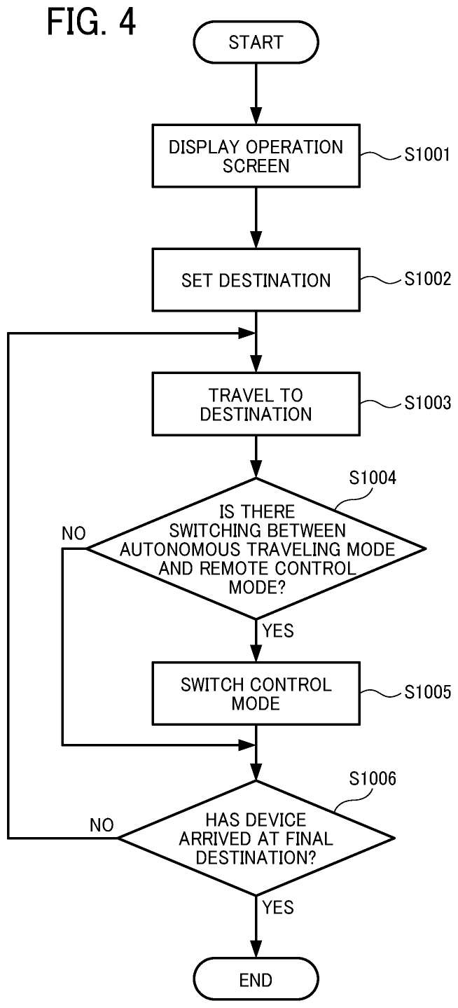

Next, control mode switching of the autonomous traveling device 110 according to the present embodiment will be described with reference to FIG. 4.

FIG. 4 is a flowchart illustrating a process of switching the control mode of the autonomous traveling device 110 in the system 100 according to the present embodiment.

In step S1001, the control terminal 120 displays an operation screen and waits for a user's operation.

Next, in step S1002, the control terminal 120 sets a destination to which the autonomous traveling device 110 is to travel according to an input of operation from the user.

The autonomous traveling device 110 then starts traveling toward the destination in step S1002.

At this time, the autonomous traveling device 110 transmits information on its own location to the control terminal 120 as the occasion arises, and the location of the autonomous traveling device 110 is reflected on a map or the like on the display screen of the control terminal 120.

Next, in step S1004, the process is branched depending on whether or not there is a switching between the autonomous traveling mode and the remote control mode.

When the switching has been performed (YES in S1004), the process proceeds to step S1005.

In step S1005, the traveling control unit 312 switches the control mode and controls the autonomous traveling device 110 to travel in the corresponding control mode (autonomous traveling mode or remote control mode).

On the other hand, when the switching is not performed (NO in S1004), the process proceeds to step S1006.

In step S1006, the process branches depending on whether or not the autonomous traveling device 110 has arrived at the final destination.

When the autonomous traveling device 110 has arrived (YES in S1006), the system 100 ends the process.

On the other hand, when the autonomous traveling device 110 has not arrived at the final destination (NO in S1006), the process returns to step S1003, and the autonomous traveling device 110 travels to the next destination. The above-described process is repeated until the autonomous traveling device 110 arrives at the final destination.

Note that, the autonomous traveling device 110 may suspend or discontinues the traveling (processing for traveling) midway to the final destination when a certain time or more has elapsed from the start of the traveling, for example, when an obstacle is detected on the traveling route, or when a stop command is received from the user.

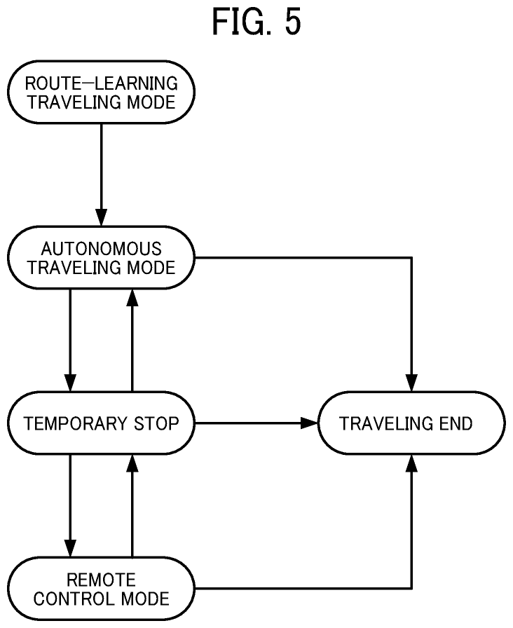

Next, mode transition of the autonomous traveling device 110 will be described with reference to FIG. 5.

FIG. 5 is a diagram illustrating the mode transition of the autonomous traveling device 110 according to the present embodiment.

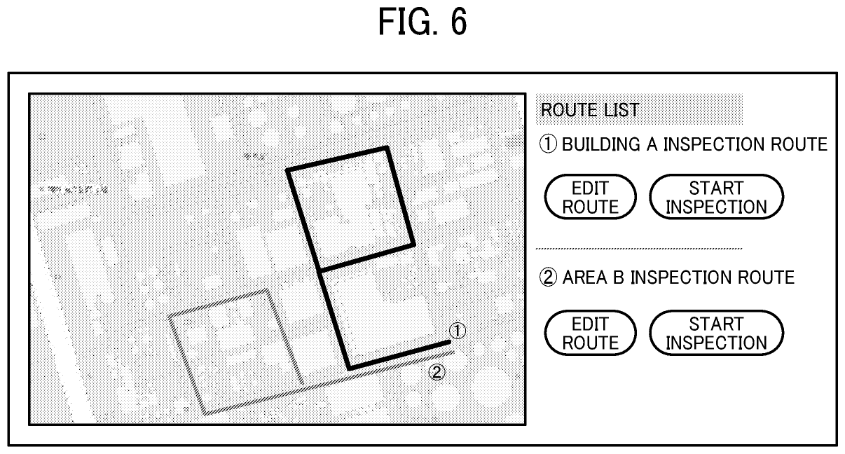

In the following description of FIG. 5, FIGS. 6 to 8B are also referred. FIGS. 6 to 8B are diagrams illustrating examples of display screens in the present embodiment.

The display screens illustrated in FIGS. 6 to 8B are displayed on the display 209 of the control terminal 120 by the notification device control unit 322, for example.

As illustrated in FIG. 5, the autonomous traveling device 110 according to the present embodiment can travel in each of a route-learning traveling mode, the autonomous traveling mode, and the remote control mode. The mode can be switched by the control terminal 120.

The route-learning traveling mode is a mode for learning a route traveled according to an operation of the user.

In the route-learning traveling mode, the position information acquired by the position acquisition unit 313 is stored in the route information storage unit 334 as needed, to create the route information for autonomous traveling.

When the route-learning traveling is completed and the route information is stored, a screen as illustrated in FIG. 6 can be displayed on the control terminal 120.

FIG. 6 illustrates an example in which two inspection routes are displayed. This screen receives editing of each route by the user operation of the control terminal 120, or receives an operation for starting inspection.

When “start inspection” is selected on the display screen of FIG. 6 after the route-learning traveling mode is ended, the autonomous traveling device 110 switches to the autonomous traveling mode.

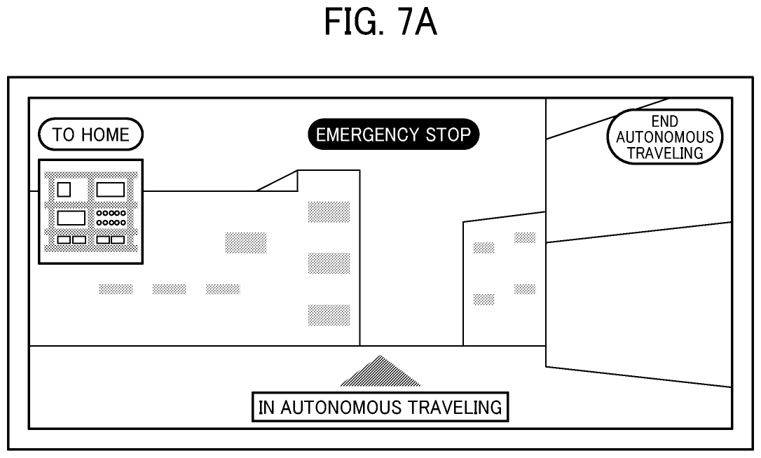

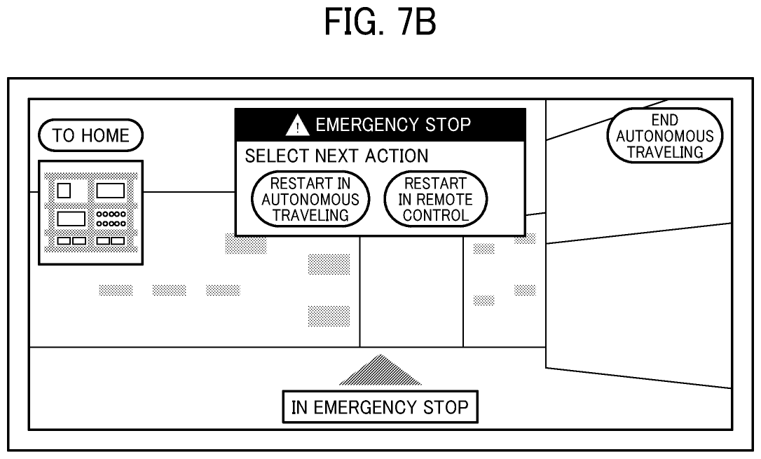

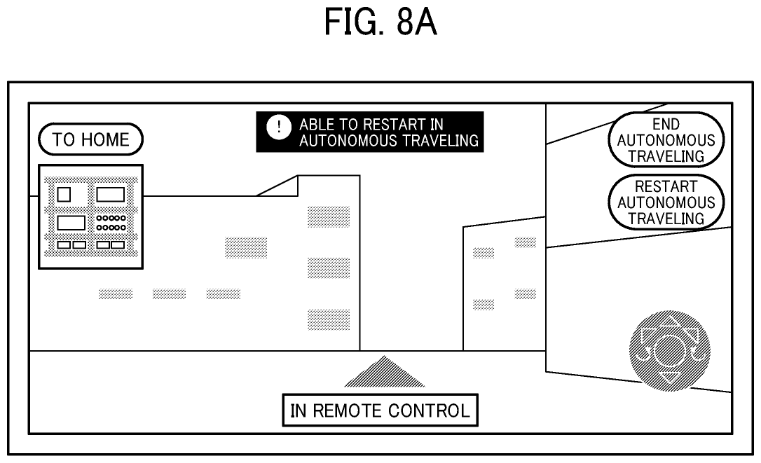

In the autonomous traveling mode, for example, a screen as illustrated in FIG. 7A is displayed on the control terminal 120.

The screen illustrated in FIG. 7A includes a surrounding image around the autonomous traveling device 110, an “emergency stop” button, an “end autonomous traveling” button, a “to home” button, a traveling route map, and a mode indication (indicating “in autonomous traveling” in FIG. 7A).

When the “emergency stop” button is selected on the display screen of FIG. 7A, the autonomous traveling device 110 temporarily stops traveling (see FIG. 5).

At this time, a screen as illustrated in FIG. 7B is displayed on the control terminal 120 to indicate that an emergency stop has occurred and buttons of options of subsequent action.

Examples of the subsequent action include restarting traveling in the autonomous traveling mode or restarting traveling in the remote control mode.

When “restart in autonomous traveling” is selected on the screen of FIG. 7B, the autonomous traveling device 110 switches from the temporary stop to the autonomous traveling mode.

When “restart in remote control” is selected, the autonomous traveling device 110 switches from the temporary stop to the remote control mode (see FIG. 5).

When the autonomous traveling device 110 temporarily stops, the autonomous traveling device 110 captures an image at that time and transmits the image (also referred to as “stop-situation image”) to the server 130 together with various pieces of information.

The server 130 can store the received stop-situation image and information at the time of temporary stop in a stop-situation storage unit 337 described later.

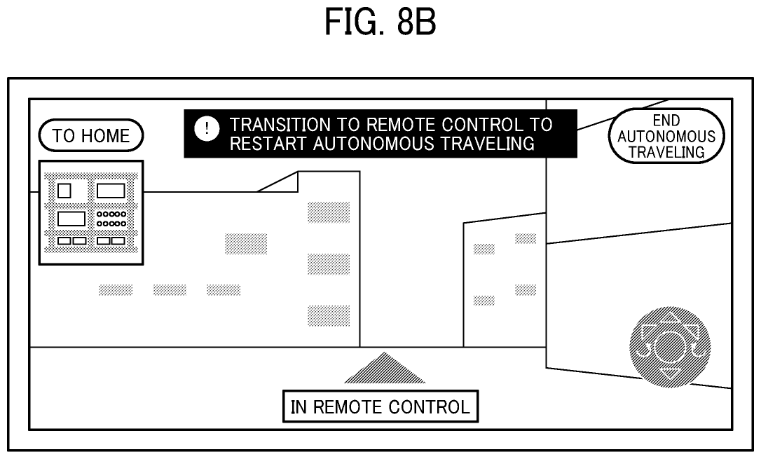

When “restart in remote control” is selected on the display screen of FIG. 7B, the display screen transitions to the display screen of FIG. 8A or 8B.

At this time, when the autonomous traveling device 110 is located on the learned route stored in the route information storage unit 334, as illustrated in FIG. 8A, a message indicating that autonomous traveling can be restarted is displayed on the control terminal 120, and a “restart autonomous traveling” button is also displayed.

On the other hand, when the autonomous traveling device 110 is not located on the learned route, as illustrated in FIG. 8B, the control terminal 120 indicates the transition to the remote control for restarting the autonomous traveling.

In this case, since the autonomous traveling device 110 is located at a position where the autonomous traveling device 110 is not capable of autonomous traveling, the “restart autonomous traveling” button is hidden (not displayed).

Instead of hiding the “restart autonomous traveling” button, for example, the “restart autonomous traveling” button may be grayed out.

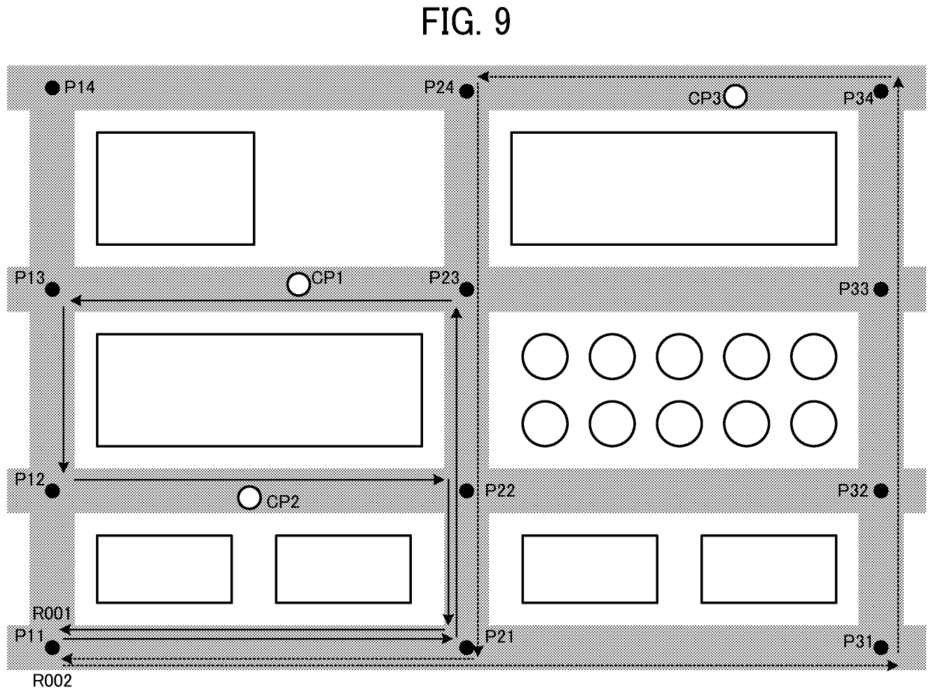

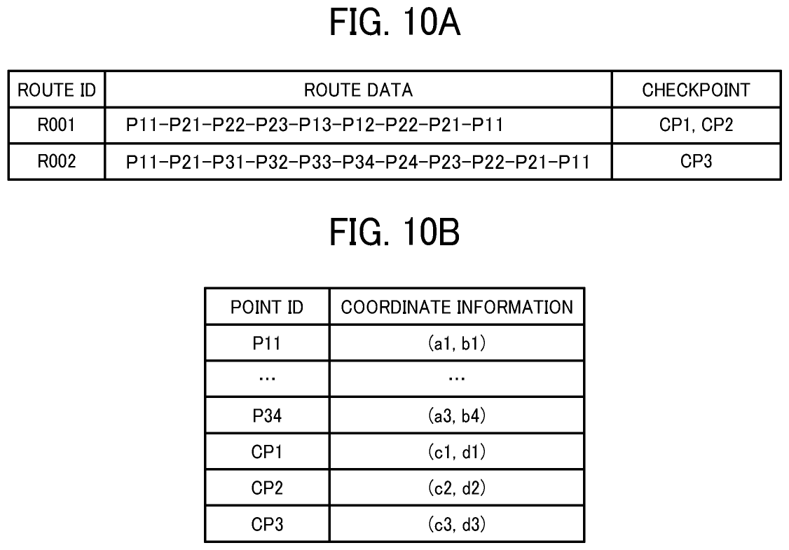

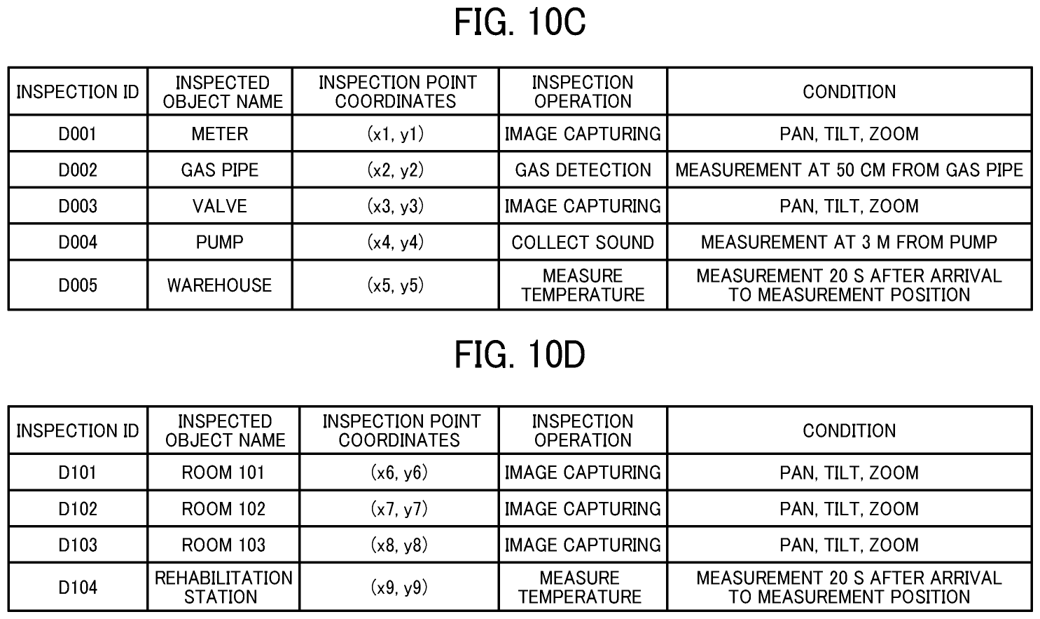

Next, the learning of the route in the route-learning traveling mode will be described with reference to FIGS. 9 and 10D.

FIG. 9 is a diagram illustrating an example of a route learned in the present embodiment.

FIGS. 10A to 10D are diagrams each illustrating tables stored in the route information storage unit 334 according to the present embodiment.

In the example illustrated in FIG. 9, two routes R001 (indicated by a solid line in FIG. 9) and R002 (indicated by a broken line in FIG. 9) are learned.

The route R001 starts from a waypoint P11, passes waypoints P21, P22, P23, P13, P12, P22, and P21 in this order, and then returns to the waypoint P11.

In the route R001, a checkpoint CP1 to be checked between the waypoints P23 and P13 and a checkpoint CP2 to be checked between the waypoints P12 and P22 are set.

The route R002 starts from the waypoint P11, passes the waypoints P21, P31, P32, P33, P34, P24, P23, P22, and P21 in this order, and returns to the waypoint P11.

In the route R002, a checkpoint CP2 to be checked is set between the waypoints P34 and P24.

The autonomous traveling device 110 may learn a route by acquiring the position information while traveling on an actual route in the route-learning traveling mode under control by the user. Alternatively, the autonomous traveling device 110 may learn a route designated on the map.

The two routes learned as illustrated in FIG. 9 are stored in the route information storage unit 334 in a format as illustrated in FIGS. 10A to 10D, for example.

FIG. 10A is an example of the route information stored in the route information storage unit 334 in a table format. In FIG. 10A, a route identifier (ID), route data, and the checkpoint illustrated in FIG. 9 are associated with each other for each route ID.

Further, as illustrated in FIG. 10B, the route information storage unit 334 can store a table in which, for each of the waypoints and checkpoints (for example, P11, P12, and CP1) to be passed through in the routes illustrated in FIG. 10A, a point ID is associated with coordinate information indicating the position of the waypoint or checkpoint.

The route information storage unit 334 may further store a table related to inspection, and the autonomous traveling device 110 may retrieve the table and perform a predetermined inspection.

For example, as illustrated in FIGS. 10C and 10D, the route information storage unit 334 can store, for each inspected object (inspection target), an inspection ID, an inspected object name, an inspection point coordinates, an inspection operation, and a condition related to the inspection, in association with each other.

FIG. 10C is an example of a table of inspection objects (points) in a factory.

For example, an inspection work having an inspection ID “D001” in FIG. 10C is to capture an image of a meter at the position (x1, y1) by panning, tilting, and zooming the camera 208.

In addition, an inspection work having an inspection ID “ID D002” in FIG. 10C is to detect gas by the sensor 207 at the position of 50 cm from a gas pipe at the position (x2, y2).

FIG. 10D is an example of a table of inspection objects (points) in a medical facility.

For example, an inspection work having an inspection ID “D101” in FIG. 10D is to capture an image of a state in a room 101 at the position (x6, y6) by panning, tilting, and zooming the camera 208.

As described above, in the inspection work, the autonomous traveling device 110 can capture an image of a measurement device at the inspection point or a state of the inspection point, or measure the environment related to the inspection point with the sensors included in the autonomous traveling device 110.

Accordingly, various facilities such as factories and medical facilities can be inspected by the unattended autonomous traveling device 110, and labor for the inspection can be reduced.

The autonomous traveling device 110 according to the present embodiment can autonomously travel on a predetermined route by appropriately retrieving data from various tables illustrated in FIGS. 10A to 10D in the route information storage unit 334, and can perform inspection work.

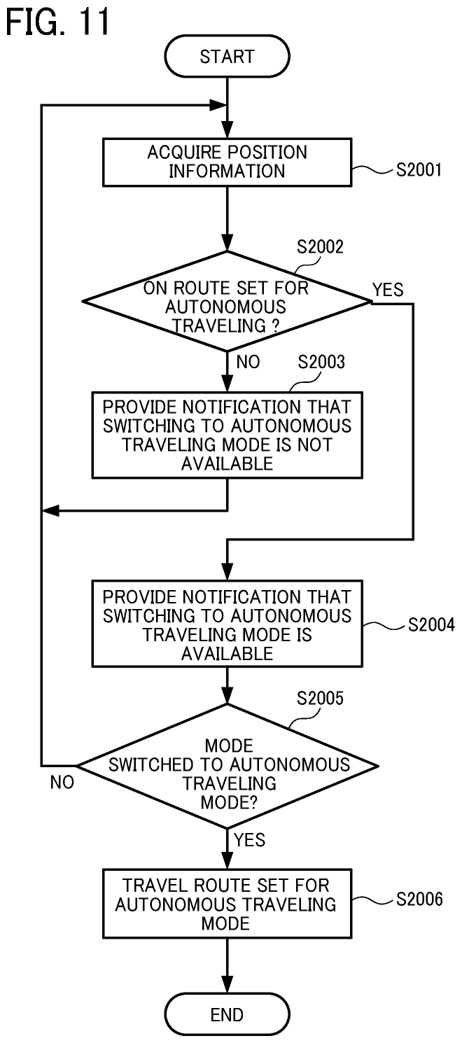

Next, a description is given of a process performed when autonomous traveling of the autonomous traveling device 110 is suspended, with reference to FIG. 11.

FIG. 11 is a flowchart illustrating the process performed when autonomous traveling is suspended in the present embodiment.

The process illustrated in FIG. 11 is started when, for example, an emergency stopping operation is performed or a mode is switched to a remote control mode while the autonomous traveling device 110 is performing autonomous traveling.

In the series of operations in FIG. 11, it is assumed that the autonomous traveling device 110 is traveling under remote control after autonomous traveling is suspended.

When the autonomous traveling is suspended, the position acquisition unit 313 acquires information on the current position of the autonomous traveling device 110 of its own in step S2001. The acquired position information is stored as suspension point information in the route information storage unit 334.

In the subsequent step S2002, the process branches depending on whether or not the position of the own autonomous traveling device 110 is on the route set for the autonomous traveling, and notification information on the switching of the mode is provided.

The position determination unit 332 performs the operation in step S2002.

The “route set for the autonomous traveling” refers to a route related to the suspended autonomous traveling.

For example, in the example of FIG. 9, it is assumed that the autonomous traveling device 110 traveling on the route R001 set for the autonomous traveling suspends the autonomous traveling. After the suspension, if the autonomous traveling device 110 is located on the route R002, it is determined that the position is not on the route set for the autonomous traveling.

When the position of the autonomous traveling device 110 is not on the route set for the autonomous traveling (NO in S2002), the process proceeds to step S2003.

In step S2003, the notification unit 333 notifies the control terminal 120 that switching to the autonomous traveling mode is not available. The notification device control unit 322 controls the notification device to provide a notification that switching to the autonomous traveling mode is not available.

The notification in step S2003 may be, for example, as illustrated in FIG. 8B, hiding or disabling (e.g., graying out) the “restart autonomous traveling” button on the control terminal 120, or displaying a message that switching to the autonomous traveling mode is not available. When the autonomous traveling device 110 is not on the autonomous traveling route and one of a first condition that the autonomous traveling is being suspended and a second condition that the autonomous traveling apparatus 110 is in the remote control mode, the notification unit 333 disables the “restart autonomous traveling” button for receiving the operation of switching to the autonomous traveling mode.

As another example of the notification, the speaker 211 may output a voice message that switching is not available, or the haptic device 212 may output vibrate of a specific pattern.

In addition to the notification in step S2003, the autonomous traveling device 110 may reject switching to the autonomous traveling mode.

After step S2003, the process returns to step S2001, and the above-described operations are repeated.

On the other hand, when the autonomous traveling device 110 is located on the route set for autonomous traveling (YES in S2002), the process proceeds to step S2004.

In step S2004, the notification unit 333 provides a notification that switching to the autonomous traveling mode is available.

Examples of the notification of step S2004 include activation of the “restart autonomous traveling” button on the screen of the control terminal 120 (see FIG. 8A), voice guidance by the speaker 211, and a specific vibration pattern of the haptic device 212.

Thereafter, the process proceeds to step S2005, and the process is branched depending on whether or not the mode is switched to the autonomous traveling mode.

When the control mode is not switched to the autonomous traveling mode (NO), the process returns to step S2001 and the above-described operations are repeated.

When the control mode is switched to the autonomous traveling mode (YES), the process proceeds to step S2006.

In step S2006, the traveling control unit 312 travels on the route set for the autonomous traveling mode. Thereafter, the process ends.

Through the process illustrated in FIG. 11, the user can easily determine whether autonomous travel is available.

In addition, based on the determination of whether the autonomous traveling device 110 is on the route set for the autonomous traveling, the user can easily grasp whether the autonomous traveling can be resumed after suspension of the autonomous traveling.

In addition, as described with reference to FIG. 11, the notification unit 333 provides the notification information on the switching between the remote control mode and the autonomous traveling mode in accordance with whether or not the autonomous traveling device 110 is on the traveling route set for autonomous traveling.

With this configuration, the user can easily determine whether or not autonomous travel is available.

Further, in step S2002, it is determined whether or not the autonomous traveling device 110 is on the route set for autonomous traveling.

This configuration allows the user to grasp whether the autonomous traveling can be resumed on the suspended traveling route.

In the present embodiment, when the autonomous traveling device 110 is on the autonomous traveling route, providing the notification information on the switching is displaying the button for restarting the autonomous traveling.

When the autonomous traveling device 110 is not on the autonomous traveling route, providing the notification information on the switching is hiding (not displaying) the button for restarting the autonomous traveling in the area for that button.

Alternatively, sound may be output as the notification information on the switching.

Specifically, a voice message that the switching is available may be output when the autonomous traveling device 110 is on the autonomous traveling route, and a voice message that the switching is not available may be output when the autonomous traveling device 110 is not on the autonomous traveling route.

Yet alternatively, when one of the voice messages is being output, the notification information on the switching may be given by stopping the voice message.

The process in a case where autonomous traveling is suspended in the present embodiment has been described above.

Next, a description will be given of a process of resuming suspended autonomous traveling.

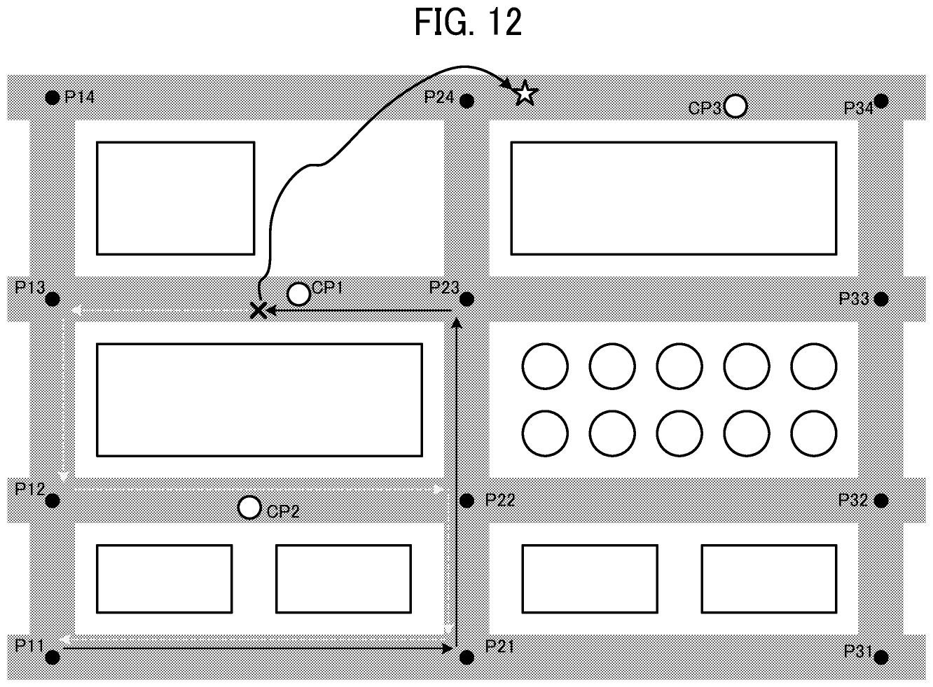

In the example described below, the autonomous traveling has been suspended as illustrated in FIG. 12.

FIG. 12 is a diagram illustrating an example of the suspended autonomous traveling of the autonomous traveling device 110 in the present embodiment.

In the example illustrated in FIG. 12, the autonomous traveling device 110 is set to autonomously travel on the route R001 illustrated in FIG. 9.

In this example, the autonomous traveling device 110 illustrated in FIG. 12 departs from the waypoint P11, passes through the waypoints P21, P22, and P23, and then stops autonomous traveling at a point (a position of a mark x in FIG. 12) past the checkpoint CP1 in midway from the waypoint P23 to the waypoint P13.

The autonomous traveling device 110 in this example has traveled to a point between the waypoints P24 and P34 (a position indicated by a star mark in FIG. 12) under the remote control of the user after the autonomous traveling has been suspended.

In the following, a description is given of resuming the suspended autonomous traveling in such a situation.

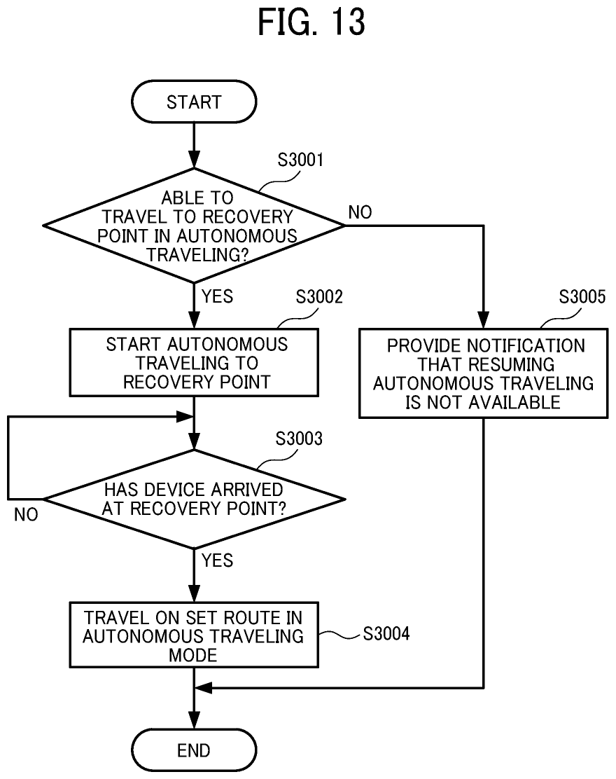

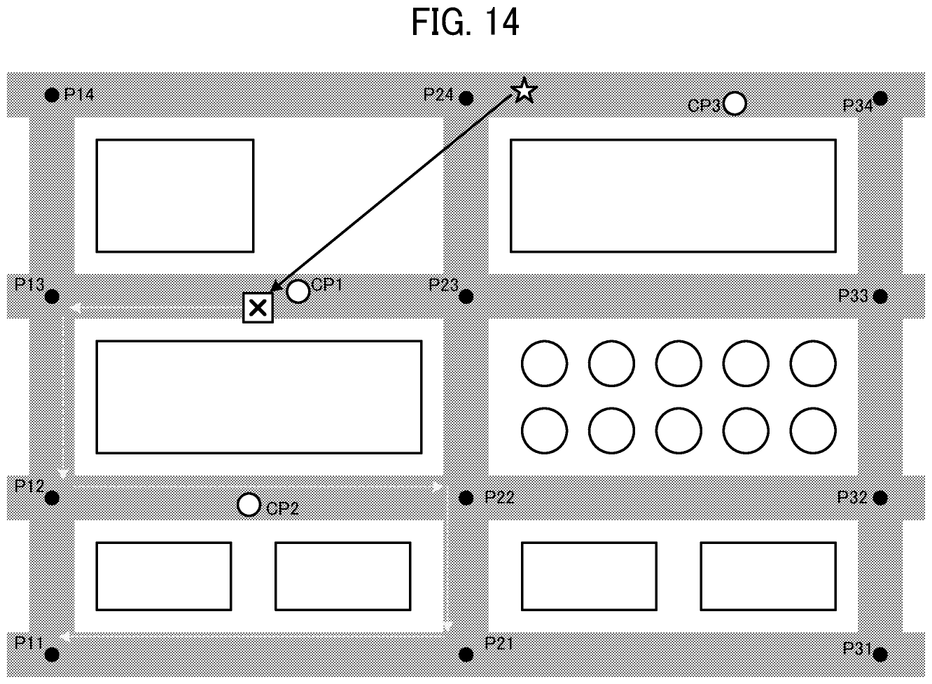

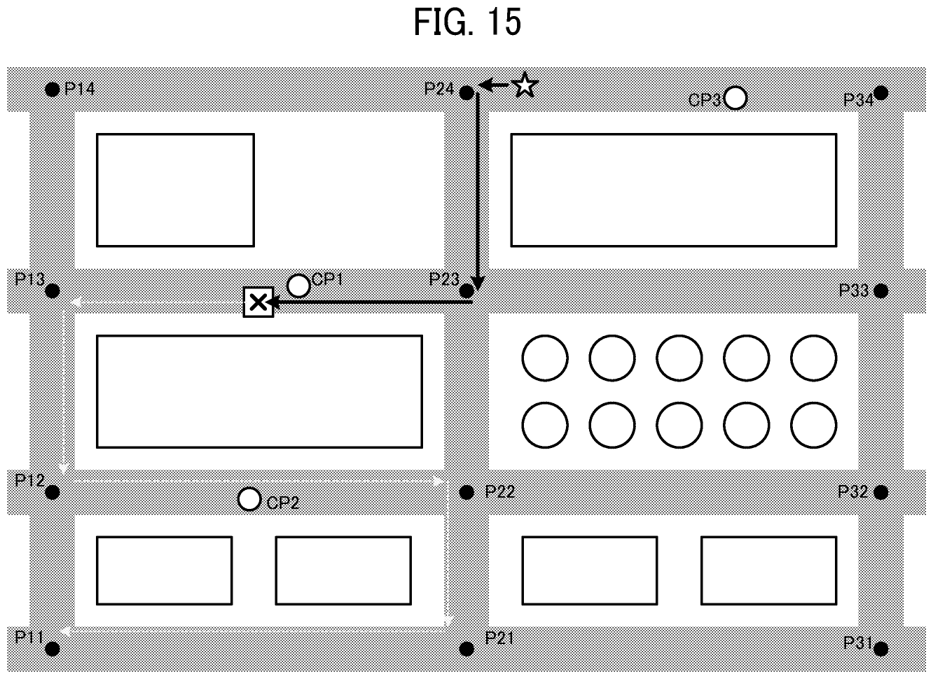

FIG. 13 is a flowchart illustrating a process of resuming the suspended autonomous traveling in the present embodiment.

The process illustrated in FIG. 13 is started in response to an operation to resume the interrupted autonomous traveling.

That is, the process illustrated in FIG. 13 is started triggered by the switching to the autonomous traveling mode after the autonomous traveling device 110 travels to the position indicated by the star mark in FIG. 12 under the remote control.

Next, in step S3001, the process is branched depending on whether or not the autonomous traveling device 110 can autonomously travel to a recovery point.

In this disclosure, “resuming” refers to resuming autonomous traveling on a set autonomous traveling route (the route R001 in this example), and the “recovery point” refers to a point at which autonomous traveling can be resumed on the set autonomous traveling route.

The recovery point may be, for example, a point where the autonomous traveling is interrupted or a point to be checked next.

The route determination unit 314 determines whether or not the autonomous traveling device 110 can autonomously travel to the recovery point, for example, based on a learned route stored in the route information storage unit 334 or a traveling history of the autonomous traveling device 110. The route determination unit 314 may determine whether or not the autonomous traveling device 110 can autonomously travel to the recovery point by combining a plurality of routes.

When the route determination unit 314 determines in step S3001 that the autonomous traveling device 110 is not able to autonomously travel to the recovery point (NO), the process proceeds to step S3005.

In step S3005, the notification unit 333 notifies the user that resuming the operation by autonomous traveling is not available.

In another embodiment, the autonomous traveling device 110 may be controlled to travel to a start point (for example, the waypoint P11) in addition to the operation of step S3005.

Thereafter, the process ends.

On the other hand, when the route determination unit 314 determines in step S3001 that the autonomous traveling device 110 is able to autonomously travel to the recovery point (YES), the process proceeds to step S3002. In step S3002, the traveling control unit 312 starts autonomous traveling to the recovery point. For example, the route determination unit 314 and the traveling control unit 312 serve as a control unit to control the autonomous traveling device 110 to return to the particular route, based on the current position information and the suspension position information.

Thereafter, in step S3003, the process is branched depending on whether or not the autonomous traveling device 110 has arrived at the recovery point. When the autonomous traveling device 110 has not arrived (NO), the process returns to step S3003, and the process is repeated until the autonomous traveling device 110 arrives at the recovery point.

When the autonomous traveling device 110 arrives at the recovery point (YES in S3003), the process proceeds to step S3004.

The branch processing in step S3003 can be determined by the position determination unit 332.

In step S3004, the traveling control unit 312 controls the autonomous traveling device 110 to travel on the route R001 set by the autonomous traveling mode, to resume the set work such as inspection. Thereafter, the process ends.

By the process illustrated in FIG. 13, the autonomous traveling device 110 according to the present embodiment can appropriately resume the suspended autonomous traveling.

Several methods are conceivable for the autonomous traveling device 110 to travel to the recovery point.

In the present embodiment, for example, the autonomous traveling device 110 autonomously (1) travels linearly from the current position to the suspension point, (2) travels to the suspension point by combining learned routes, (3) travels to a checkpoint subsequent to the suspension point by combining learned routes, or (4) traces back a route from the suspension point to the current position on which the autonomous traveling device 110 has traveled under the remote control.

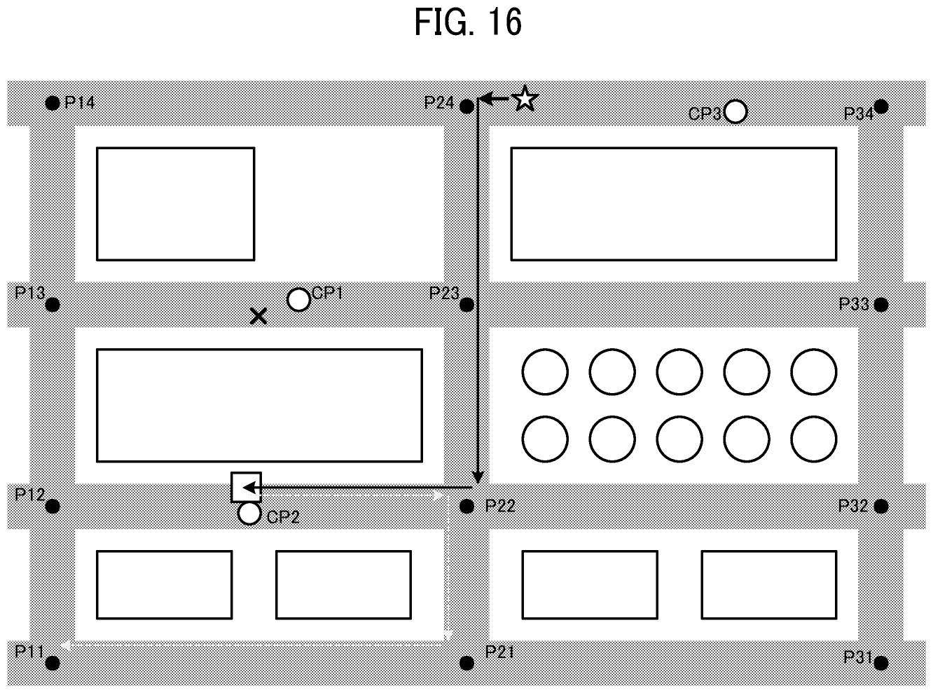

Next, various methods will be described with reference to FIGS. 14 to 17.

FIGS. 14 to 17 are diagrams illustrating first to fourth methods for the autonomous traveling device 110 to travel to the recovery point in the present embodiment.

In FIGS. 14 to 17, similar to FIG. 12, a mark x indicates a point at which autonomous traveling is suspended, a star mark indicates a point to which the autonomous traveling device 110 travels under remote control after the suspension, and a square mark indicates a point (recovery point) at which the autonomous traveling is resumed.

The first method will be described. In the first method for traveling to the recovery point, as illustrated in FIG. 14, the autonomous traveling device 110 autonomously travels linearly from the current position to the suspension point.

For example, the route determination unit 314 determines whether there is an obstacle on a linear route connecting the current position of the autonomous traveling device 110 and the suspension point, based on the image captured by the camera 208. When determining that there is no obstacle on the linear route, in step S3001 of FIG. 13, the route determination unit 314 determines that the autonomous traveling device 110 can autonomously travel on a linear route connecting the current position and the recovery point (that is, the suspension point). After the autonomous traveling device 110 arrives at the recovery point (S3003), the autonomous traveling on the route R001 is resumed from the recovery point (S3004).

The second method is described. In the second method for traveling to the recovery point, the autonomous traveling device 110 autonomously travels to the suspension point by combining the learned routes as illustrated in FIG. 15.

Specifically, by combining a part of the learned route R002 (the way from the waypoints P34 to P24 and the way from the waypoints P24 to P23) and a part of the route R001 (the way from the waypoints P23 to P13), an autonomous traveling route from the current position to the suspension point is established.

Therefore, in step S3001 of FIG. 13, the route determination unit 314 determines that traveling to the suspension point which is the recovery point is available by combining the learned routes.

After the autonomous traveling device 110 arrives at the recovery point (S3003), the autonomous traveling on the route R001 is resumed from the recovery point (S3004).

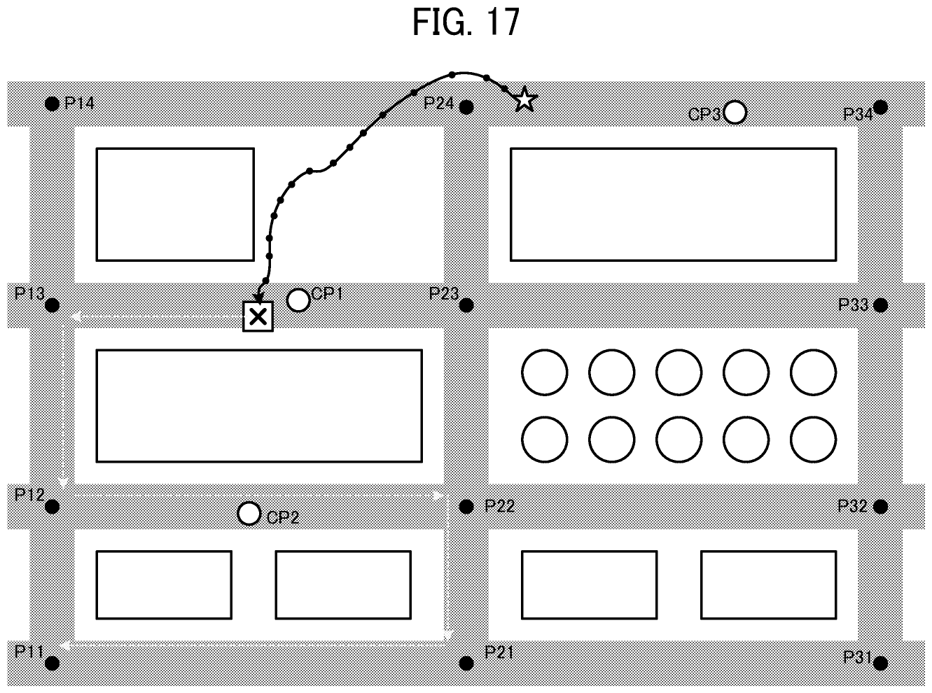

The third method is described. In the third method for traveling to the recovery point, as illustrated in FIG. 16, the autonomous traveling device 110 autonomously travels to a next checkpoint subsequent to the suspension point by combining the learned routes.

Since the purpose of autonomous traveling is to execute predetermined work such as inspection, it is not necessary to resume the autonomous traveling from the suspension point as long as the autonomous traveling device 110 travels to, for example, a checkpoint.

Therefore, in the third method, in the route R001 set for autonomous traveling, the checkpoint CP1 next to the passed checkpoint CP2 is set as a recovery point, and autonomous traveling is resumed.

In this case, by combining a part of the learned route R002 (the way from the waypoints P34 to P24 and the way from the waypoints P24 to P22) and a part of the route R001 (the way from the waypoints P12 to P22), an autonomous traveling route from the current position to the checkpoint CP2 is established.

Therefore, in step S3001 of FIG. 13, the route determination unit 314 determines that traveling to the checkpoint CP2 which is the recovery point is available by combining the learned routes.

After the autonomous traveling device 110 arrives at the recovery point (S3003), the autonomous traveling on the route R001 is resumed from the recovery point (S3004).

The fourth method is described. In the fourth method for traveling to the recovery point, as illustrated in FIG. 17, the autonomous traveling device 110 autonomously traces back the route on which the autonomous traveling device 110 has traveled from the suspension point to the current position under remote control.

In the fourth method, the route traveled under remote control after suspension of autonomous traveling is stored in the route information storage unit 334, and the autonomous traveling device 110 autonomously traces back the stored route to the suspension point. Thus, the returns autonomous traveling device 110 returns to the suspended route.

When the route traveled under remote control is stored in this way, in step S3001 of FIG. 13, the route determination unit 314 can determine that traveling to the suspension point is available by autonomously traveling on the stored route.

After the autonomous traveling device 110 arrives at the recovery point (S3003), the autonomous traveling on the route R001 is resumed from the recovery point (S3004).

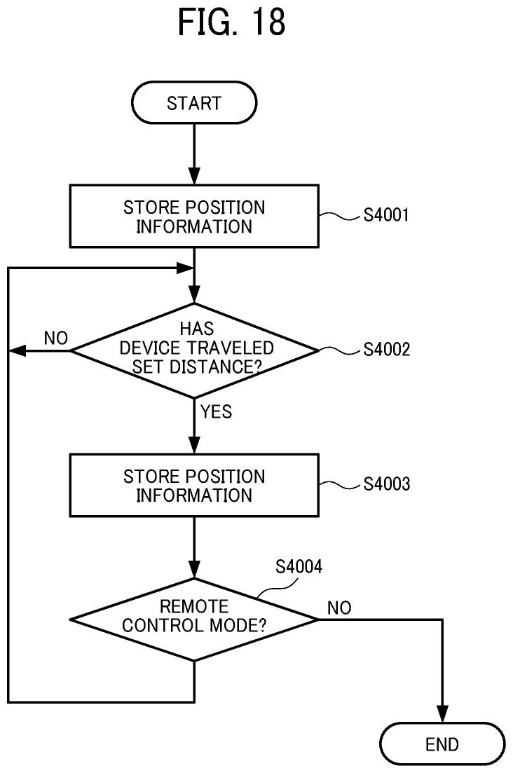

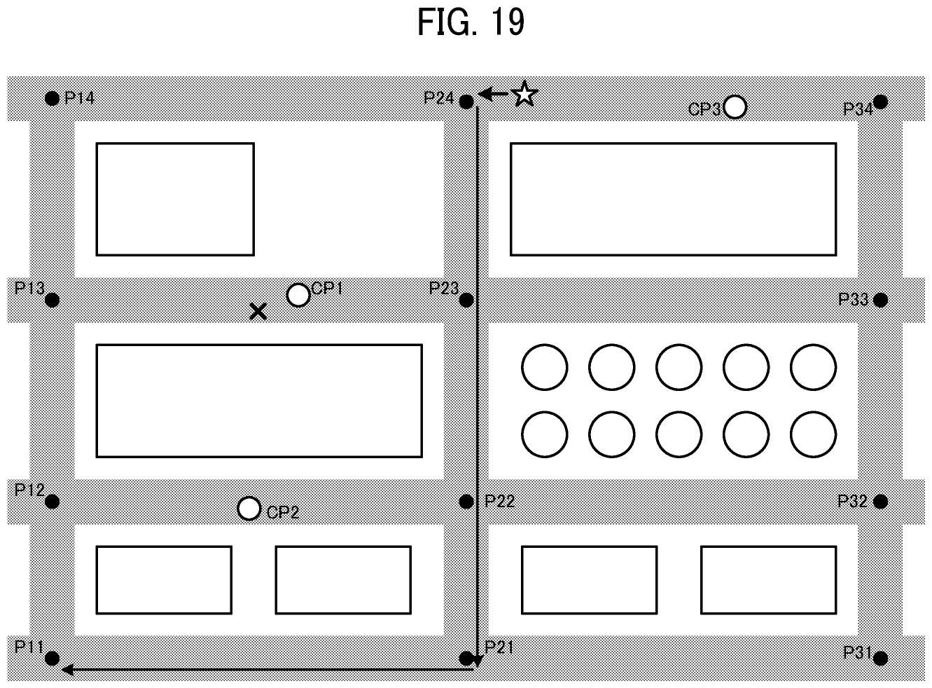

The process of storing the traveling route in the fourth method will be described with reference to FIG. 18.

FIG. 18 is a flowchart illustrating the process for the autonomous traveling device 110 having suspended autonomous traveling stores a route in the present embodiment.

After the suspension of the autonomous traveling, the autonomous traveling device 110 starts the process, triggered by the start of the remote control.

In step S4001, the position acquisition unit 313 acquires position information representing the current position of the autonomous traveling device 110, and stores the position information in the route information storage unit 334 as the route information related to the remote control.

With this operation, the position information representing the suspension point is stored.

Thereafter, in step S4002, the process is branched depending on whether or not a predetermined distance has been traveled under remote control.

That is, in the present embodiment, at regular intervals, a traveling route plotted is stored as route information.

When the distance traveled under remote control is shorter than the predetermined distance (NO), the process returns to step S4002. The process is repeated until the distance traveled under remote control reaches the predetermined distance.

On the other hand, when the distance traveled under the remote control reaches the predetermined distance (YES), the process proceeds to step S4003.

The branch processing in step S4002 can be determined by the position determination unit 332.

In step S4003, similar to step S4001, the position acquisition unit 313 acquires position information representing the current position of the autonomous traveling device 110, and stores the position information in the route information storage unit 334 as the route information related to the remote control.

Thereafter, in step S4004, the process is branched depending on whether or not the remote control mode continues.

When the autonomous traveling device 110 is not in the remote control mode, that is, has switched to the autonomous traveling mode (NO), the process of storing the route information ends.

The branch processing in step S4004 can be determined by the state of the traveling control unit 312.

If the remote control mode continues (YES), the process returns to step S4002, and the above-described process is repeated until the remote control mode ends.

Thus, the information on the route traveled under the remote control is stored in the route information storage unit 334 as the route information at a constant interval of distance.

So far, the first to fourth methods for the autonomous traveling device 110 to travel to the recovery point in the present embodiment have been described.

The method for the autonomous traveling device 110 to travel to the recovery point is not limited to any one of the first to fourth methods described above, and a plurality of traveling methods may be adopted in the autonomous traveling device 110.

In addition, an executable one of the first to fourth methods for traveling may be presented to the user so that the user can freely select the method.

Next, a description is given of a case where the autonomous traveling device 110 is not able to autonomously travel to the recovery point, with reference to FIG. 19.

FIG. 19 is a diagram illustrating an example in which the autonomous traveling device 110 is not able to autonomously travel to the recovery point in the present embodiment.

Specifically, FIG. 19 illustrated an example of an operation performed based on a determination in step S3001 of FIG. 13 that autonomous travel to the recovery point is not available.

In such a case, the user is notified that resuming the operation by autonomous traveling is not available (step S3005).

At this time, in some cases, the autonomous traveling device 110 is not able to autonomously travel to the recovery point but can travel to a predetermined position such as a start point of the autonomous traveling by using the learned route.

When the autonomous traveling device 110 can return to the start point, re-performing autonomous traveling would be easy.

In the example described with reference to FIG. 19, the autonomous traveling device 110 can autonomously return from the current position to the start point (P11) by combining a part of the learned route R002 (the way from the waypoints P34 to P24 and the way from the waypoints P24 to P21) and a part of the route R001 (the way from the waypoints P21 to P11). Therefore, the route determination unit 314 specifies such a route so that and the autonomous traveling device 110 returns to the start point.

Accordingly, the user can easily determine the next operation of the autonomous traveling device 110.

In the embodiment described so far, the system 100 includes the autonomous traveling device 110, the control terminal 120, and the server 130 as illustrated in FIG. 1.

The system 100 is not limited thereto. Aspects of the present disclosure are applicable to a system 100 including the autonomous traveling device 110 and the control terminal 120 without the server 130.

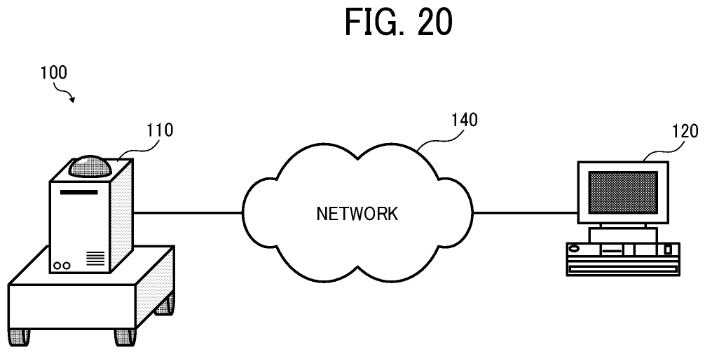

A description is given below of such a configuration as a second embodiment, with reference to FIG. 20.

FIG. 20 is a schematic diagram illustrating a hardware configuration of the system 100 according to the second embodiment.

As illustrated in FIG. 20, in the system 100 according to the second embodiment, the autonomous traveling device 110 and the control terminal 120 are connected via the network 140.

That is, the second embodiment is different from the first embodiment illustrated, for example, in FIG. 1 in that the server 130 is not included.

Since the details of each device illustrated in FIG. 20 are similar to those described with reference to FIG. 1, redundant descriptions will be omitted. As will be described later, each function of the server 130 in FIG. 1 is provided in the autonomous traveling device 110 or the control terminal 120.

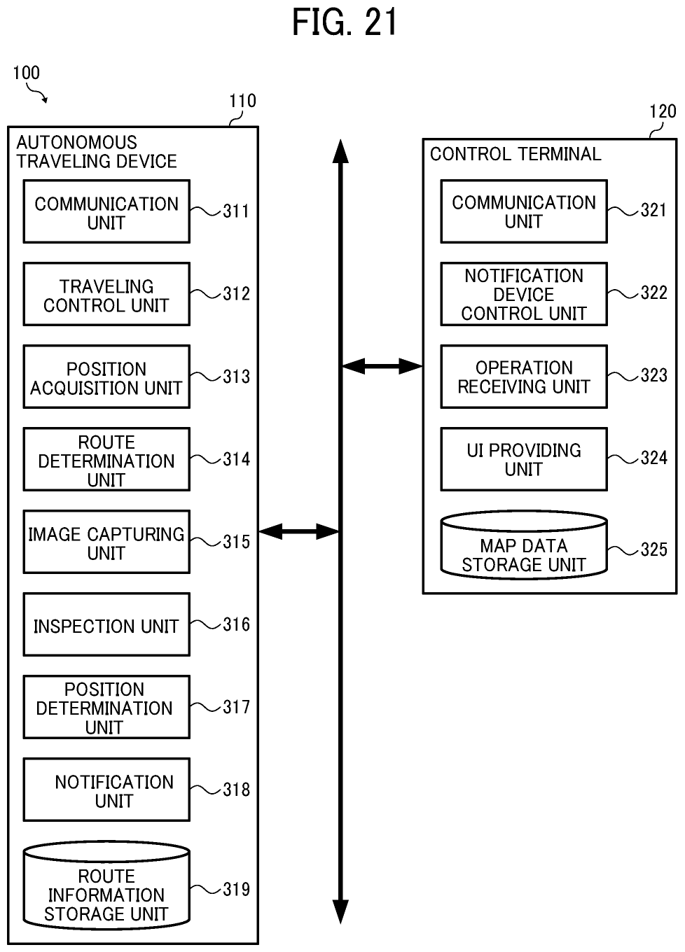

FIG. 21 is a block diagram illustrating a software configuration of the system 100 according to the second embodiment.

In the second embodiment, as illustrated in FIG. 21, the autonomous traveling device 110 includes, as functional units, the communication unit 311, the traveling control unit 312, the position acquisition unit 313, the route determination unit 314, the image capturing unit 315, the inspection unit 316, a position determination unit 317, a notification unit 318, and a route information storage unit 319.

The control terminal 120 according to the second embodiment includes the communication unit 321, the notification device control unit 322, the operation receiving unit 323, a UI providing unit 324, and a map data storage unit 325.

The functional units illustrated in FIG. 21 are similar to those described with reference to FIG. 3, and will not be described in detail.

The software blocks described above correspond to functional units implemented by the CPU 201 executing a program of the present embodiment, to operate the hardware components.

In any one of the embodiments, all of the functional units may be implemented by software, hardware, or a combination of software and hardware.

Further, all of the above-described functional units do not necessarily have to be in the blocks as illustrated in FIG. 21.

For example, the control terminal 120 may include the position determination unit 317 and the route information storage unit 319. Alternatively, the autonomous traveling device 110 may include only functional units related to autonomous traveling and inspection, and other functional units may be included in the control terminal 120.

Since various functions and processing provided by the above-described functional units are similar to those described with reference to FIGS. 4 to 19, a detailed description thereof will be omitted.

In the second embodiment, the functions provided by the server 130 in FIG. 1 or the like are executed by another device.

Hereinafter, a third embodiment will be described.

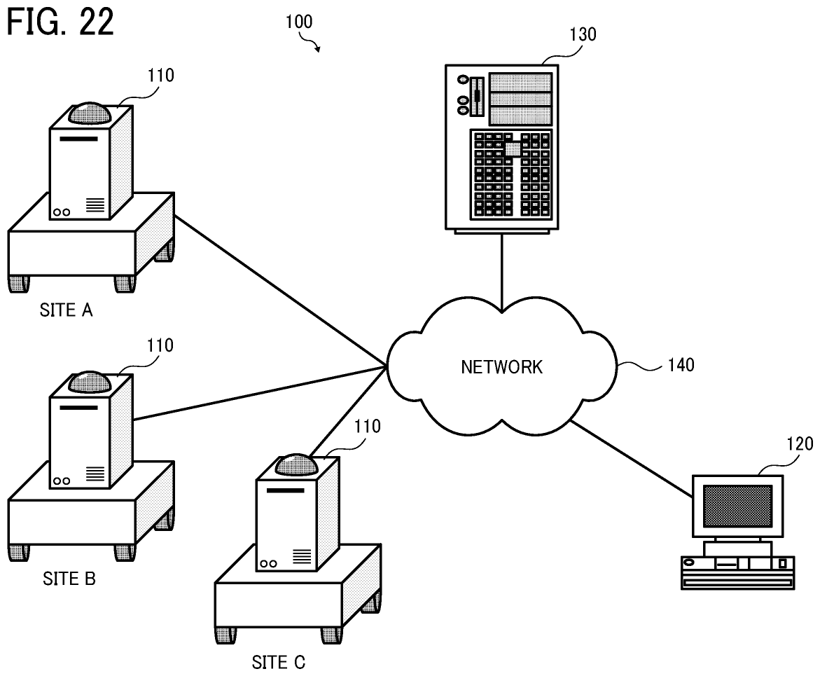

FIG. 22 is a schematic diagram illustrating a hardware configuration of the system 100 according to the third embodiment.

In the third embodiment illustrated in FIG. 22, similar to the first embodiment illustrated in FIG. 1, autonomous traveling devices 110, the control terminal 120, and the server 130 that provides services according to the present embodiment are connected via the network 140.

The server 130 is a computer that provides services according to the present embodiment.

The network 140 provides communication between devices via the Internet, a local area network (LAN), or the like.

As illustrated in FIG. 22, in the third embodiment, the autonomous traveling device 110 is present in each of a plurality of sites A to C.

Note that a plurality of sites is illustrated in FIG. 22 for convenience of description, and the present embodiment is applicable to a case where there is only one site.

That is, FIG. 22 is an example configuration that does not limit the present embodiment, and the number of sites may be one or more.

Details of each device in FIG. 22 are similar to those described with reference to FIG. 1, and thus description thereof will be omitted.

The single control terminal 120 illustrated in FIG. 22 may control the operations of the autonomous traveling devices 110 at the plurality of sites.

Alternatively, in the system 100 of FIG. 22, the autonomous traveling device 110 at each site may be individually controlled by corresponding one or more control terminals 120.

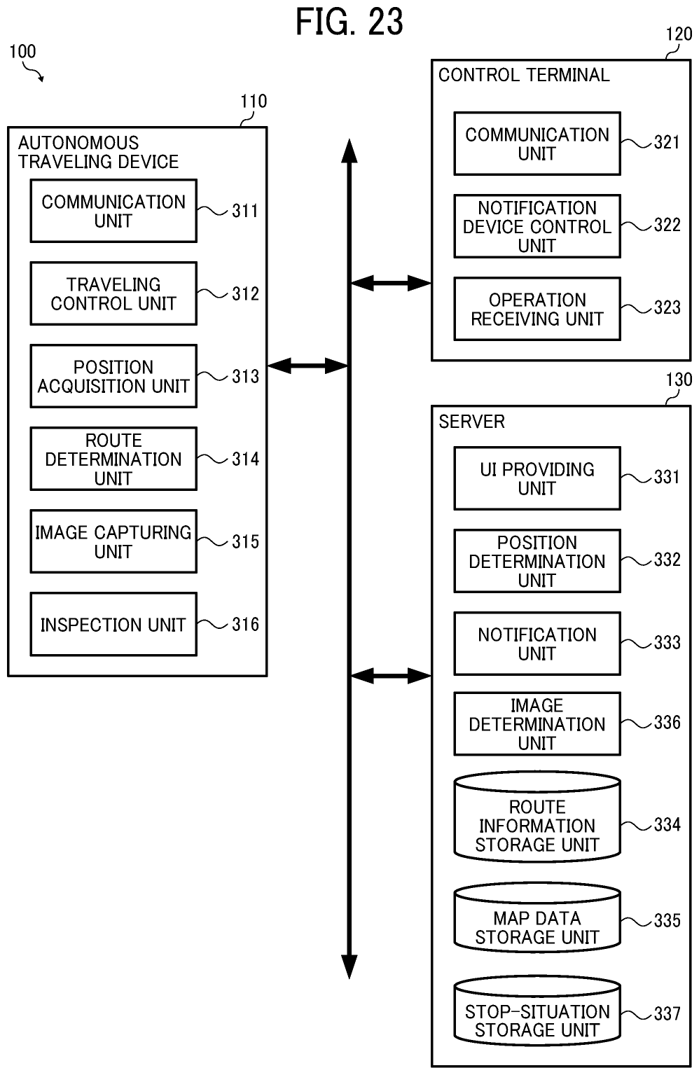

FIG. 23 is a block diagram illustrating a software configuration of the system 100 according to the third embodiment.

The autonomous traveling device 110 includes, as functional units, the communication unit 311, the traveling control unit 312, the position acquisition unit 313, the route determination unit 314, the image capturing unit 315, and the inspection unit 316.

The control terminal 120 according to the third embodiment includes, as functional units, the communication unit 321, the notification device control unit 322, and the operation receiving unit 323.

The server 130 according to the third embodiment includes, as functional units, the UI providing unit 331, the position determination unit 332, the notification unit 333, an image determination unit 336, the route information storage unit 334, the map data storage unit 335, and the stop-situation storage unit 337.

Note that, among the functional units illustrated in FIG. 23, the functional units other than the image determination unit 336 and the stop-situation storage unit 337 are similar to those described in FIG. 3, and thus a detailed description thereof will be omitted.

The image determination unit 336 compares a stop-situation image captured in the past with a currently captured image of the surrounding situation of the autonomous traveling device 110 that is traveling. The stop-situation image is an image capturing a surrounding situation in which the autonomous traveling device 110 stopped in the past. Then, the image determination unit 336 determines the degree of matching of the surrounding situation between the stop-situation image and the currently captured image.

In a case where the degree of matching of the surrounding situation is equal to or greater than a threshold value, the notification unit 333 provides the user of information on a stop of the autonomous traveling device 110. The notification unit 333 notifies the user that the probability that the autonomous traveling device 110 stops traveling is high, or that stopping the autonomous traveling device 110 is desirable.

The stop-situation storage unit 337 stores an image captured when the control terminal 120 performs an operation for stopping the autonomous traveling device 110 or an image captured when the autonomous traveling device 110 makes an emergency stop, in association with various pieces of information.

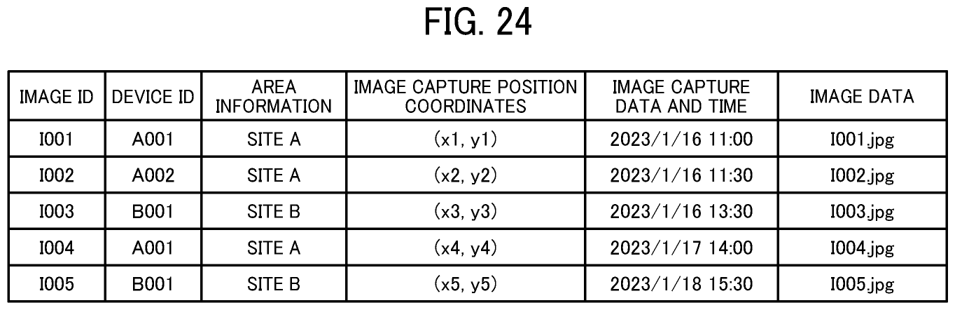

The information stored in the stop-situation storage unit 337 will be described with reference to FIG. 24.

FIG. 24 illustrates an example of a table stored in the stop-situation storage unit 337 according to the third embodiment.

As illustrated in FIG. 24, the stop-situation storage unit 337 according to the present embodiment stores a stop situation table in which items of an image ID, a device ID, area information, image capture position coordinates, image capture date and time, and image data (of the stop-situation image) are associated with each other.

The items included in the stop situation table stored in the stop-situation storage unit 337 illustrated in FIG. 24 are merely examples. The number of items included in the stop situation table may be smaller than that illustrated in FIG. 24, or the stop situation table may include items other than those illustrated in FIG. 24.

The image ID is an ID identifying a stop-situation image captured when the autonomous traveling device 110 stops.

The image ID may be any ID that can uniquely identify the image acquired from the autonomous traveling device 110. For example, the image ID may be generated from information included in the data of the image.

For example, in the case where the data of the image includes manufacturing information unique to the camera and the date and time of the image capturing, the ID can be generated from the combination thereof.

The device ID is an ID identifying the autonomous traveling device 110 that has captured the image.

In another example, the device ID is an ID that identifies, instead of the autonomous traveling device 110, for example, a camera mounted on the autonomous traveling device 110.

As an example, when the image file of the image acquired from the autonomous traveling device 110 includes manufacturing information unique to the camera, the device ID can be generated based on the manufacturing information.

The area information indicates an area in which the stop-situation image is captured.

In the present embodiment, the area is, for example, the operation site (e.g., site A or site B) at which the autonomous traveling device 110 is located.

The server 130 manages the autonomous traveling device 110 and the control terminal 120, in particular, manages each device in association with the operation site. Accordingly, the server 130 can specify the operation site in which the autonomous traveling device 110 that has transmitted the captured image is present and use the operation site as the area information.

The image capture position coordinates indicate the coordinates of the position at which the stop-situation image is captured.

The image capture position coordinates of the stop-situation image are obtained by the position acquisition unit 313 of the autonomous traveling device 110 acquiring the position at the time of stop using, for example, a GPS or the like.

The image capture date and time is the date and time when the stop-situation image was captured.

That is, the image capture date and time indicates the date and time when the autonomous traveling device 110 stopped.

For example, the image capture date and time may be the date and time of generation of the image file of the image acquired from autonomous traveling device 110, included in the image file.

The image data is data representing a stop-situation image.

The image data stored in the stop-situation storage unit 337 may store, instead of the image file itself, image data association information indicating, e.g., a file name, or a path of a folder storing the stop-situation image.

The description continues referring back to FIG. 23.

The functional units in FIG. 23 common to those in FIG. 3 function similar to those in FIG. 1.

In addition, in the present embodiment, the notification unit 333 can notify that the probability that the autonomous traveling device 110 stops is high (or stopping the autonomous traveling device 110 is desirable) on the basis of the determination result by the image determination unit 336.

The software blocks described above correspond to functional units implemented by the CPU 201 executing a program of the present embodiment, to operate the hardware components.

In any one of the embodiments, all of the functional units may be implemented by software, hardware, or a combination of software and hardware.

Further, all of the above-described functional units do not necessarily have to be in the blocks as illustrated in FIG. 23.

For example, the control terminal 120 may include the UI providing unit 331, the map data storage unit 335, and the route determination unit 314. Alternatively, the autonomous traveling device 110 or the control terminal 120 may include the route information storage unit 334.

For example, in another embodiment, any one of the above-described functional units may be implemented by cooperation among the autonomous traveling device 110, the control terminal 120, and the server 130.

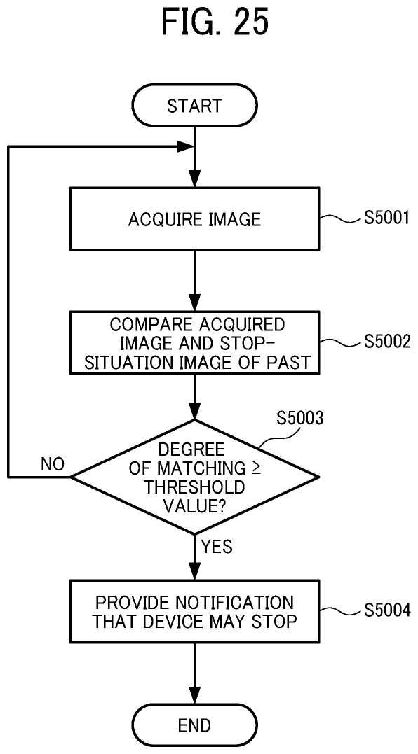

Next, the process executed in the third embodiment is described, with reference to FIG. 25.

FIG. 25 is a flowchart illustrating a process for notification of a probability of stop in the third embodiment.

Although, in the example description below, the server 130 executes the process in FIG. 25, alternatively, the system 100 may execute the process in FIG. 25.

In step S5001, the server 130 acquires an image captured by the autonomous traveling device 110 that is traveling.

Next, in step S5002, the image determination unit 336 compares the image acquired in step S5001 with the stop-situation image of past, read from the stop-situation storage unit 337.

The autonomous traveling device 110 makes an emergency stop or stops by the operation of the control terminal 120 in a situation in which, for example, there is an unexpected obstacle on the traveling route on which the autonomous traveling device 110 can generally travel.

In this case, the image capturing device (the camera 208 in FIG. 2A) mounted in the autonomous traveling device 110 captures a characteristic image indicating an obstacle on the traveling route, for example, an image indicating a person or an animal.

Other examples of the situation in which the autonomous traveling device 110 makes an emergency stop or stops by the operation of the control terminal 120 include a case where the posture of the autonomous traveling device 110 greatly changes.

In this case, the image capturing device mounted in the autonomous traveling device 110 captures a characteristic image indicating, for example, a large temporal change or a shift in the horizontal direction.

Such a situation can occur in any place. The system 100 can cope with various situations by storing stop-situation images captured at a plurality of sites in the stop-situation storage unit 337 as in the present embodiment.

The comparison in step S5002 can be performed by, for example, extracting a characteristic portion of the image.

In step S5003, the process is branched depending on whether or not the degree of matching between the compared images is equal to or greater than the threshold value.

When the degree of matching is smaller than the threshold value (NO in S5003), the process returns to step S5001 to acquire the next image.

When the degree of matching is equal to or greater than the threshold value (YES in S5003), that is, the image captured by the autonomous traveling device 110 is similar to the stop-situation image of past, the image determination unit 336 determines that the probability that the corresponding autonomous traveling device 110 stops is high. Then, the process proceeds to step S5004.

In step S5004, the notification unit 333 provides a notification that there is the probability that the autonomous traveling device 110 stops.

As a result, the user can recognize that the autonomous traveling device 110 needs to stop due to the situation surrounding, and can take measures such as performing an avoidance operation.

Thereafter, the process ends.

Through the process illustrated in FIG. 25, when a captured image indicates the situation that may cause the autonomous traveling device 110 to stop, the system 100 can determine that the autonomous traveling device 110 that has captured the image may stop and notify the user of the probability of stop.

As described above, the embodiments of the present disclosure provide the information processing system and the autonomous traveling body capable of facilitating the determination of whether autonomous travel is possible.

Each of the functions of the embodiments of the present disclosure can be implemented by a device-executable program written in, for example, C, C++, C#, and JAVA. The program according to an embodiment of the present disclosure can be stored in a device-readable recording medium to be distributed. Examples of the recording medium include a hard disk drive, a compact disk read-only memory (CD-ROM), a magneto-optical disk (MO), a digital versatile disk (DVD), a flexible disk, an electrically erasable programmable read-only memory (EEPROM), and an erasable programmable read-only memory (EPROM). The program can be transmitted over a network in a form executable with another computer.

Although several embodiments of the present disclosure have been described above, embodiments of the present disclosure are not limited thereto, and various modifications may be made without departing from the spirit and scope of the present disclosure that can be estimated by skilled person. Such modifications exhibiting functions and effects of the present disclosure are within the scope of the present disclosure.

Aspects of the present disclosure may include, but are not limited to, the following.

A first aspect of the present disclosure concerns an information processing system for controlling an autonomous traveling body capable of autonomously traveling on a learned route. The information processing system includes a storage unit to store suspension point information indicating a suspension point at which the autonomous traveling body has suspended autonomous traveling on a particular route that is a learned route, and an acquisition unit to acquire current position information indicating a current position of the autonomous traveling body according to an instruction to resume the autonomous traveling.

The information processing system controls the autonomous traveling body to travel to the particular route on which the autonomous traveling has been suspended, based on at least the current position information and the suspension point information.

In a second aspect, the information processing system according to the first aspect further includes a determination unit to determine presence or absence of a route for autonomous traveling to a recovery point on the particular route.

In a third aspect, in the information processing system according to the second aspect, the determination unit determines whether or not the autonomous traveling body is able to autonomously travel linearly from the current position to the suspension point.

In a fourth aspect, in the information processing system according to the second or third aspect, the determination unit determines whether or not the autonomous traveling body is able to autonomously travel from the current position to the suspension point using one or more leaned routes stored in the storage unit.

In a fifth aspect, in the information processing system according to any one of the second to fourth aspects, the determination unit determines whether or not the autonomous traveling body is able to autonomously travel from the current position to a waypoint on the particular route, using one or more leaned routes stored in the storage unit.

In a sixth aspect, in the information processing system according to any one of the second to fifth aspects, the autonomous traveling body performs switching between an autonomous traveling mode and a remote control mode in which the autonomous traveling body is controlled to travel by a remote operation.

Further, the storage unit stores a remote control route on which the autonomous traveling body has traveled in the remote control mode after the autonomous traveling is suspended.

Further, the determination unit determines whether or not the autonomous traveling body is able to autonomously travel from the current position to the suspension point, using the remote control route.

In a seventh aspect, in the information processing system according to any one of the second to sixth aspects, when the determination unit determines that the autonomous traveling body is not able to autonomously travel to the recovery point, the autonomous traveling device travels to a start point of the particular route.

In an eighth aspect, the information processing system according to any one of the first to seventh aspects further includes an image capturing device configured to capture an image of surroundings of the autonomous traveling body at a predetermined position on the route when the autonomous traveling body is autonomously traveling.

In a ninth aspect, the information processing system according to any one of the first to eighth aspects further includes an inspection unit to check a temperature at a predetermined position on the route when the autonomous traveling body is autonomously traveling.

In a tenth aspect, in the information processing system according to the eighth aspect or the ninth aspect, the autonomous traveling body autonomously travels a factory site.

In an eleventh aspect, in the information processing system according to the eighth aspect or the ninth aspect, the autonomous traveling body autonomously travels a medical facility.

A twelfth aspect concerns an autonomous traveling body capable of autonomously traveling on a learned route. The autonomous traveling body includes a storage unit to store suspension point information indicating a suspension point at which the autonomous traveling body has suspended autonomous traveling on a particular route that is a learned route, an acquisition unit to acquire current position information indicating a current position of the autonomous traveling body according to an instruction to resume the autonomous traveling, and a control unit to control the autonomous traveling body to travel to the particular route on which the autonomous traveling has been suspended, based on the current position information and the suspension point information.

The above-described embodiments are illustrative and do not limit the present invention.

Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.”

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application Nos. 2022-046426, filed on Mar. 23, 2022, 2022-046373, filed on Mar. 23, 2022, 2023-011214, filed on Jan. 27, 2023, and 2023-011034, filed on Jan. 27, 2023, in the Japan Patent Office, the entire disclosure of which is hereby incorporated by reference herein.

### REFERENCE SIGNS LIST

100 System
110 Autonomous traveling device
120 Control terminal
130 Server
140 Network
201 CPU
202 RAM
203 ROM
204 Memory
205 Communication I/F
206 Traveling unit
207 Sensor
208 Camera
209 Display
210 Input device
211 Speaker
212 Haptic device
240 Memory
311 Communication unit
312 Traveling control unit
313 Position acquisition unit
314 Route determination unit
315 Image capturing unit
316 Inspection unit
317 Position determination unit
318 Notification unit
319 Route information storage unit
321 Communication unit
322 Notification device control unit
323 Operation receiving unit
324 UI providing unit
325 Map data storage unit
331 UI providing unit
332 Position determination unit
333 Notification unit
334 Route information storage unit
335 Map data storage unit
336 Image determination unit
337 Stop-situation storage unit

1: An information processing system for controlling an autonomous traveling body capable of autonomously traveling on a learned route, the information processing system comprising:
route information memory to store suspension point information indicating a suspension point at which the autonomous traveling body has suspended autonomous traveling on a particular route that is a learned route;
acquisition circuitry configured to acquire current position information indicating a current position of the autonomous traveling body according to an instruction to resume the autonomous traveling; and
control circuitry configured to control the autonomous traveling body to return to the particular route, based on at least the current position information and the suspension point information.

2: The information processing system according to claim 1, further comprising:
determination circuitry configured to determine whether there is a route for autonomous traveling to a recovery point at which the autonomous traveling body resumes the autonomous traveling on the particular route.

3: The information processing system according to claim 2, wherein:
the recovery point is the suspension point, and
the determination circuitry is configured to determine whether the autonomous traveling body is able to autonomously travel on a linear route from the current position to the suspension point.

4: The information processing system according to claim 2, wherein:
the recovery point is the suspension point, and
the determination circuitry is configured to determine whether the autonomous traveling body is able to autonomously travel from the current position to the suspension point using one or more leaned routes stored in the route information memory.

5: The information processing system according to claim 2, wherein:
the recovery point is a waypoint on the particular route, and
the determination circuitry is configured to determine whether the autonomous traveling body is able to autonomously travel from the current position to the waypoint using one or more leaned routes stored in the route information memory.

6: The information processing system according to claim 2, wherein:
the autonomous traveling body is configured to switch a traveling mode between an autonomous traveling mode and a remote control mode in which the autonomous traveling body is controlled to travel by a remote operation,
the memory is to store a remote control route on which the autonomous traveling body has traveled in the remote control mode after the autonomous traveling is suspended,
the recovery point is the suspension point, and
the determination circuitry is configured to determine whether the autonomous traveling body is able to autonomously travel from the current position to the suspension point on the stored remote control route.

7: The information processing system according to claim 2, wherein:
based on a determination by the determination circuitry that there is no route for autonomous traveling to the recovery point, the autonomous traveling device is configured to travel to a start point of the particular route.

8: The information processing system according to claim 1, further comprising:
an image capturer to capture an image of surroundings of the autonomous traveling body at a set position on the particular route in autonomous traveling.

9: The information processing system according to claim 1, further comprising:
inspection circuitry configured to check a temperature at a set position on the particular route in autonomously traveling.

10: The information processing system according to claim 8, wherein:
the autonomous traveling body is configured to autonomously travel a factory site.

11: The information processing system according to claim 8, wherein:
the autonomous traveling body is configured to autonomously travel a medical facility.

12: The information processing system according to claim 1, further comprising:
an image capturer mounted in the autonomous traveling body and to capture an image of surroundings of the autonomous traveling body;
a control terminal to receive an operation by a user;
a stop-situation memory to store the image captured by the image capturer in response to a stop of the autonomous traveling body according to the operation by the user;
a determination circuitry configured to determine a degree of matching between the image stored in the stop-situation memory with an image captured by the autonomous traveling body while the autonomous traveling body travels; and
a notification circuitry configured to provide information on the stop of the autonomous traveling body based on a determination that the degree of matching is equal to or greater than a threshold value.

13: An autonomous traveling body for autonomously traveling on a learned route, the autonomous traveling body comprising:
a route information memory to store suspension point information indicating a suspension point at which the autonomous traveling body has suspended autonomous traveling on a particular route that is a learned route;
an acquisition circuitry configured to acquire current position information indicating a current position of the autonomous traveling body according to an instruction to resume the autonomous traveling; and
a control circuitry configured to control the autonomous traveling body to return to the particular route, based on the current position information and the suspension point information.

14-32. (canceled)
